(19) United States
(12) Patent Application Publication
(10) Pub. No.: US 2005/0051758 A1
(43) Pub. Date: Mar. 10, 2005

(54) Photorefractive composition

(76) Inventors: Michiharu Yamamoto, Carlsbad, CA (US); Sheng Li, Vista, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/658,307

(22) Filed: Sep. 9, 2003

(51) Int. Cl. C08L 83/04; F21V 9/00; G02C 7/10

(52) U.S. Cl. 252/582; 524/860

(57) ABSTRACT

A composition comprising a polymer represented by the following formula (i), wherein the composition exhibits photorefractive ability: 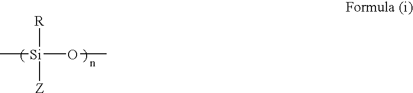
wherein R is selected from the group consisting of a linear alkyl group with up to 10 carbons, a branched alkyl group with up to 10 carbons, and an aromatic group with up to 10 carbons; n is an integer of 10 to 10,000; Z is a group which contains at least a tri-aromatic amine moiety shown in the structure (ii): 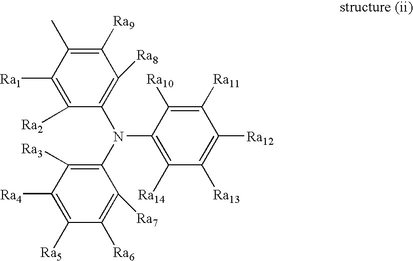
wherein Ra₁-Ra₁₄ are independently selected from the group consisting of a hydrogen atom, a linear alkyl group with up to 10 carbons, a branched alkyl group with up to 10 carbons, and an aromatic group with up to 10 carbons.

### BACKGROUND OF THE INVENTION

1. Field of the Invention

The invention relates to photorefractive compositions. More particularly, the invention relates to photorefractive compositions comprising polysiloxane having tri-arylamine moiety at side chain. Furthermore, the composition can also contain chromophore(s) which provide photorefractive capabilities.

2. Description of the Related Art

Photorefractivity is a phenomenon in which the refractive index of a material can be altered by changing the electric field within the material, such as by laser beam irradiation. The change of the refractive index is achieved by a series of steps, including: (1) charge generation by laser irradiation, (2) charge transport, resulting in the separation of positive and negative charges, and (3) trapping of one type of charge (charge delocalization), (4) formation of a non-uniform internal electric field (space-charge field) as a result of charge delocalization, and (5) refractive index change induced by the non-uniform electric field.

Therefore, good photorefractive properties can be seen only for materials that combine good charge generation, good charge transport or photoconductivity, and good electro-optical activity.

Photorefractive materials have many promising applications, such as high-density optical data storage, dynamic holography, optical image processing, phase conjugated mirrors, optical computing, parallel optical logic, and pattern recognition.

Originally, the photorefractive effect was found in a variety of inorganic electro-optical (EO) crystals, such as LiNbO₃. In these materials, the mechanism of the refractive index modulation by the internal space-charge field is based on a linear electro-optical effect.

In 1990 and 1991, the first organic photorefractive crystal and polymeric photorefractive materials were discovered and reported. Such materials are disclosed, for example, in U.S. Pat. No. 5,064,264, to Ducharme et al. Organic photorefractive materials offer many advantages over the original inorganic photorefractive crystals, such as large optical nonlinearities, low dielectric constants, low cost, lightweight, structural flexibility, and ease of device fabrication. Other important characteristics that may be desirable depending on the application include sufficiently long shelf life, optical quality, and thermal stability. These kinds of active organic polymers are emerging as key materials for advanced information and telecommunication technology.

In recent years, efforts have been made to optimize the properties of organic, and particularly polymeric, photorefractive materials. As mentioned above, good photorefractive properties depend upon good charge generation, good charge transport, also known as photoconductivity, and good electro-optical activity. Various studies that examine the selection and combination of the components that give rise to each of these features have been done. The photoconductive capability is frequently provided by incorporating materials containing carbazole groups. Phenyl amine groups can also be used for the charge transport part of the material.

Non-linear optical ability is generally provided by including chromophore compounds, such as an azo-type dye, which can absorb photon radiation. The chromophore may also provide adequate charge generation. Alternatively, a material known as a sensitizer may be added to provide or boost the mobile charge required for photorefractivity to occur. Many materials, including a wide range of dyes and pigments, can serve as sensitizers.

The photorefractive composition may be made simply by mixing the molecular components that provide the individual properties required into a host polymer matrix. However, most compositions prepared in this way are not stable over time, because phase separation tends to occur as the components crystallize.

Efforts have been made, therefore, to make polymers that include one or more of the active components in the polymer structure.

An example of a polymer matrix that includes transport components is poly(n-vinylcarbazole) (PVK). With such a matrix, polymers with high performance could be fabricated as reported by N. Peyghambarian et al. (Nature, 1994, 371, 497).

In this case, a photorefractive composition was made by adding an azo dye (DMNPAA; 2,5-dimethyl-4-(p-nitrophenylazo) anisole) as chromophore, and trinitrofluorenone (TNF) as sensitizer. The resulting compositions showed almost 100% diffraction efficiency at laser intensity of 1 W/cm² and 90 V/m biased voltage. However, the response time was slow at over 100 msec.

To achieve good photorefractivity, however, such materials must be doped with large concentrations of chromophore, such as 25 wt % or more. Thus, crystallization and phase separation of the strongly dipolar chromophore remain a major problem.

To completely eliminate the instability caused by phase separation, it has been recognized that it would be desirable to prepare fully functionalised photorefractive polymers, that is, polymers in which both the photoconductivity and the non-linear optical capability reside within the polymer itself.

Building on the original University of Arizona work, efforts have been made to develop fully functional photorefractive polymers, as well as to speed up the response time. For example, PVK polymers in which some of the carbazole groups are tricyanovinylated have been made (N. Peyghambarian et al., Applied Phys. Lett., 1992, 60, 1803). However, the photoconductivity of this polymer was reported as only 0.98 pS/cm and the diffraction efficiency was less than 1%, too low to show good photorefractivity. Subsequently, the same group has reported PVK-based materials with a response time of 4 msec. (N. Peyghambarian et al., Applied Physics Letters, 1999, 16, 2253).

A number of efforts at materials improvement have used methacrylate-based polymers and copolymers that include photoconductive and chromophore side groups. A paper by T. Kawakami and N. Sonoda, (Applied Phys. Lett., 1993, 62, 2167.) discloses acrylate-based polymers containing dicyanovinylideneyl phenylamines as charge transport groups. The diffraction efficiency was reported at around 0.01%.

Japanese Patent Application Laid-open JP-A 1995-318992, to Hitachi Ltd. discloses acrylate-based polymers and copolymers made by conventional polymerization techniques and containing charge transport and non-linear-optical groups, but gives no photorefractive performance data.

A report by H. Sato et al., (Technical report of IEICE., 1995, OME-95-53, OPE95-94, 43) describes the preparation of several copolymers having both charge transport components and non-linear optical components in the side groups of the copolymer. However, the charge transport speeds seem to be too slow for good photorefractive materials.

Japanese Patent Application Laid-open JP-A 1998-333195, to Showa Denko, discloses acrylate-based polymers incorporating triphenylamine groups as charge transport agents. Fast response times (50 msec. at 70 V/m biased voltage) is reported, although there is no description or data regarding diffraction efficiency.

A paper by Van Steenwickel et al. (Macromolecules, 2000, 33, 4074) describes acrylate-based polymers that include carbazole-based side chains and several stilbene-type side chains. The paper cites a high diffraction efficiency of 60% at 58 V/m, but a slow response time of the sub-second order.

A paper by Y. Chen et al. (Modern Optics, 1999, 46, 1003) discusses a methacrylate polymer that has both carbazole-type side chains to provide charge transport capability and nitrophenyl azo-type side chains to provide non-linear optical capability. The materials again show slow response times of over 20 sec.

A paper by N. Kim et al. (Molecular Cryst., 2000, 349, 43) discusses a polysiloxane polymer that has carbazole-type side chains to provide charge transport capability and benzylidenemalononitrile chromophore to provide non-linear optical capability.

A paper by R. TWieg et al. (Polymeric Materials Science and Engineer., 1996, 75, 165) discusses a polysiloxane polymer that has carbazole-type side chains to provide charge transport capability and nitro-diaminoaniline chromophore to provide non-linear optical capability. The material show low diffraction efficeincy 34% (8 kV), although there are no discription about the response time.

None of the materials described above achieves the combination of a high diffraction efficiency with a fast response time, long-term stability and easy processability. Thus, there remains a need for photorefractive compositions that combine these attributes.

### SUMMARY OF THE INVENTION

The object of the present invention is to provide a photorefractive composition which exhibits fast response time and high diffraction efficiency, along with very good composition stability which is desirably used for the photorefractive composition.

A first aspect of the present invention is a composition comprising a polymer represented by the formula (i): 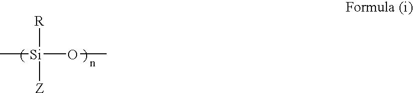
wherein R is selected from the group consisting of a linear alkyl group with up to 10 carbons, a branched alkyl group with up to 10 carbons, and an aromatic group with up to 10 carbons; n is an integer of 10 to 10,000; Z is a group which contains at least a tri-aromatic amine moiety shown in the structure (ii): 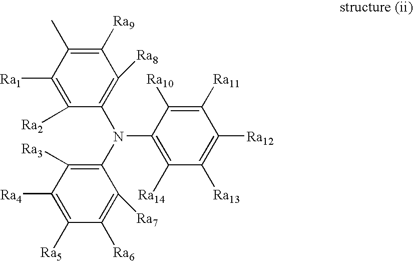
wherein Ra₁-Ra₁₄ are independently selected from the group consisting of a hydrogen atom, a linear alkyl group with up to 10 carbons, a branched alkyl group with up to 10 carbons, and an aromatic group with up to 10 carbons.

Particularly, the structure (ii) is preferably represented by a structure selected from the group consisting of the structures (iii) and (iv); 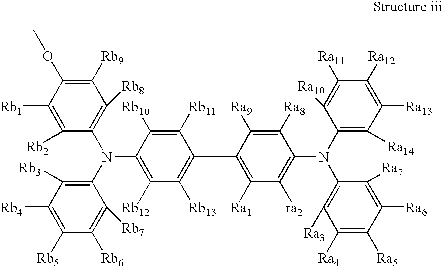
wherein Q represents an alkylene group, with or without a hetero atom, such as oxygen or sulfur, and preferably Q is an alkylene group represented by (CH₂)p, where p is an integer of about 2 to 6; and wherein Rb₁-Rb₁₃ and Ra₁-Ra₁₄ are independently selected from the group consisting of a hydrogen atom, a linear alkyl group with up to 10 carbons, a branched alkyl group with up to 10 carbons, and an aromatic group with up to 10 carbons; and 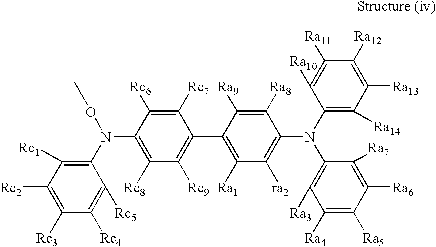
wherein Q represents an alkylene group, with or without a hetero atom, such as oxygen or sulfur, and preferably Q is an alkylene group represented by (CH₂)p, where p is an integer of about 2 to 6; and wherein Rc₁-Rc₉ and Ra₁-Ra₁₄ are independently selected from the group consisting of a hydrogen atom, a linear alkyl group with up to 10 carbons, a branched alkyl group with up to 10 carbons, and an aromatic group with up to 10 carbons. A second aspect of the present invention is a composition comprising mixture of a polymer represented by the formula (i) and at least one chromophore selected from the group consisting of the formulae (v), (vi), (vii), and (viii) wherein the composition exhibits photorefractive ability. Firstly, in the formula (v) 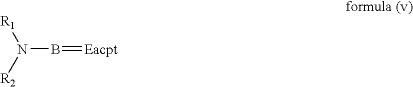
wherein R₁ and R₂ are selected from the group consisting of a linear alkyl group with up to 10 carbons, a branched alkyl group with up to 10 carbons, and an aromatic group with up to 10 carbons; R₁ and R₂ can be either same or different; wherein B is a group having a bridge of—conjugated bond; and Eacpt is an electron acceptor group. Particularly, in the formula (v);
B is preferably a group selected from the group consisting of the structures (ix), (x) and (xi);
wherein the structures (ix), (x) and (xi) are: 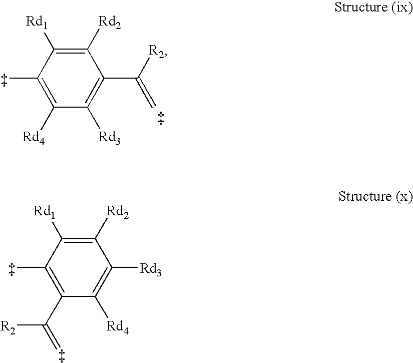
wherein, in the both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 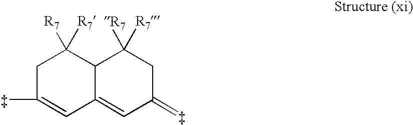
wherein R₇, R₇′, R₇″, and R₇′″ each independently represent a hydrogen or a linear or branched alkyl group with up to 10 carbons; and
wherein Eacpt in the formula (v) is preferably an electron acceptor group represented by a structure selected from the group consisting of the structures; 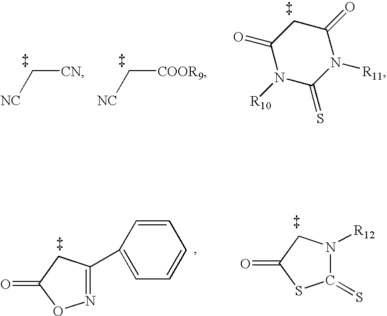
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

Secondly, in the formula (vi) 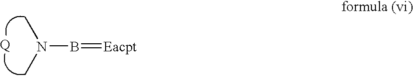
wherein Q represents an alkylene group, with or without a hetero atom; wherein B is a group having a bridge of-conjugated bond; and Eacpt is an electron acceptor group.

Particularly, in the formula (vi);
B is preferably a group selected from the group consisting of the structures (ix), (x) and (xi);
wherein the structures (ix), (x) and (xi) are: 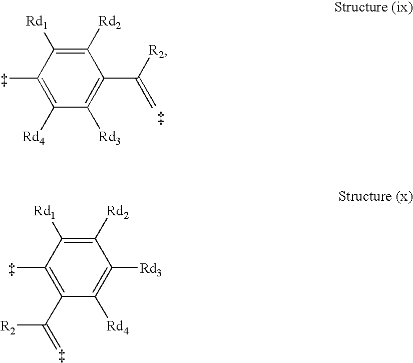
wherein, in the both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 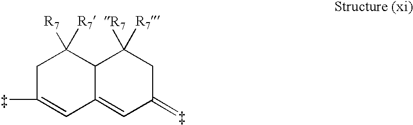
wherein R₇, R₇′, R₇″, and R₇′″ each independently represent a hydrogen or a linear or branched alkyl group with up to 10 carbons; and

Eacpt in the formula (vi) is preferably an electron acceptor group represented by a structure selected from the group consisting of the structures; 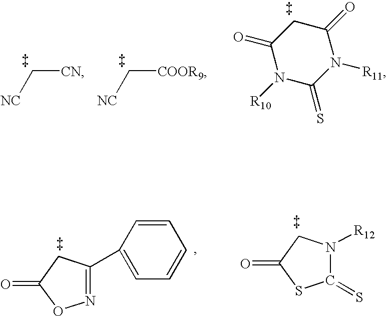
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

Thirdly, in the formula (vii) 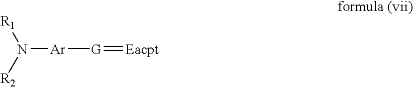
wherein Ar represents an aromatic group, with or without a hetero atom; R₁ and R₂ are selected from the group consisting of a linear alkyl group with up to 10 carbons, a branched alkyl group with up to 10 carbons, and an aromatic group with up to 10 carbons; R₁ and R₂ can be either same or different; G is a group having a bridge of—conjugated bond; and Eacpt is an electron acceptor group.

Particularly, in the formula (vii);
Ar is preferably an aromatic group selected from phenylene, naphthylene, or thiophenylene.
G in the formula (vii) is preferably represented by a structure selected from the group consisting of the structures (xii) and (xiii);
wherein the structures (xii) and (xiii) are: 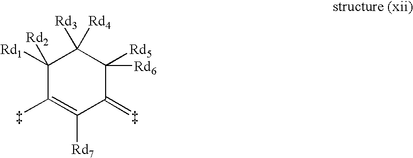
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 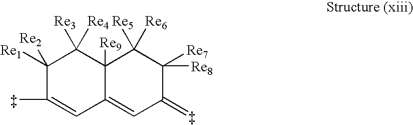
wherein Re₁-Re₉ each independently represent a hydrogen or a linear or branched alkyl group with up to 10 carbons; and

Eacpt in the formula (vii) is preferably an electron acceptor group represented by a structure selected from the group consisting of the structures; 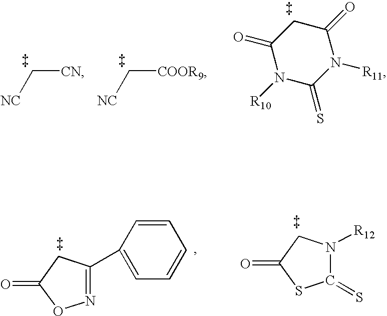
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

Fourthly, in the formula (viii) 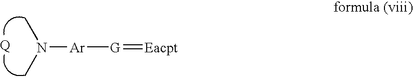
wherein Ar represents an aromatic group, with or without a hetero atom; G is a group having a bridge of—conjugated bond; and Eacpt is an electron acceptor group; Q represents an alkylene group, with or without a hetero atom.

Particularly, in the formula (viii),
Ar is preferably an aromatic group selected from phenylene, naphthylene, and thiophenylene;G in the formula (viii) is preferably represented by a structure selected from the group consisting of the structures (xii) and (xiii);
wherein the structures (xii) and (xiii) are: 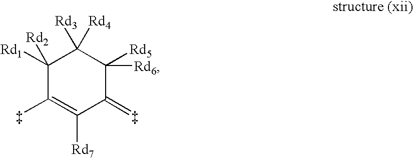
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 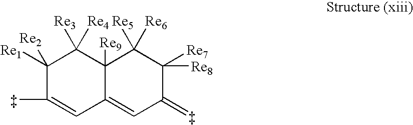
wherein Re₁-Re₉ each independently represent a hydrogen or a linear or branched alkyl group with up to 10 carbons; and

Eacpt in the formula (viii) is preferably an electron acceptor group represented by a structure selected from the group consisting of the structures; 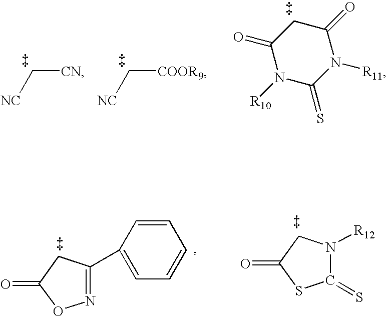
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

A third aspect of the present invention is a composition comprising a chromophore and a polymer, further comprising a plascticizer and a sensitizer, wherein the composition exhibits photorefractive ability.

The composition differs from photorefractive compositions previously known in the art in several points.

In a first point, the composition according to a preferred embodiment of the present invention provides fast response time compared with conventional photoconductive materials, and/or one or more other advantageous properties, such as high diffraction efficiency and high photoconductivity. Furthermore these properties can typically be provided in conjunction with one or more other desirable attributes, such as excellent handling and processing capability.

In a second point, the composition according to a preferred embodiment of the present invention comprises a polymer and shows very good phase stability, that is, resistance to phase separation.

In a third point, the composition comprises a polysiloxane based polymer containing the photoconductive side group.

With respect to the first point of the invention, inventors have found, to inventors' surprise, that inventors' preferred photorefractive compositions exhibit high response times, such as 50 ms or less.

With respect to the second point of the invention, inventors have developed photorefractive polymers which are composed of a component that provides photoconductive (charge transport) ability and a component that provides non-linear optical ability. Since the chromophore have unique chemical structures and more mixisible tendencies with polysioloxane based matrix polymer, the composition still provides the long-term stability.

The photorefractive compositions according to a preferred embodiment of the present invention have great utility in a variety of optical applications, including holographic storage, optical correlation, phase conjugation, non-destructive evaluation and imaging.

### DETAILED DESCRIPTION OF THE PREFERRED EMBODIMENT

The invention relates to photorefractive compositions. More particularly, the invention relates to photorefractive compositions comprising polysiloxane having a tri-arylamine moiety at side chain. Furthermore, the composition can also contain particular chromophore(s) which provide good photorefractive capabilities.

Optionally, the composition may also include other components as desired, such as sensitizer and plasticizer components.

The polymer that provides the photoconductivity may be any structure known in the art to provide such capability.

Preferred polymer structures are polysiloxane which contain a triaryl amino-type moiety at side chains.

The polymer that provides the photoconductivity used in the present invention is represented by the formula (i): 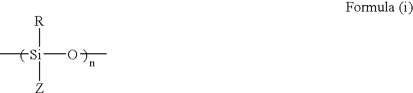
wherein R is selected from the group consisting of a linear alkyl group with up to 10 carbons, a branched alkyl group with up to 10 carbons, and an aromatic group with up to 10 carbons; n is an integer of 10 to 10,000; Z is a group which contains at least a tri-aromatic amine moiety that is shown in the structure (ii): 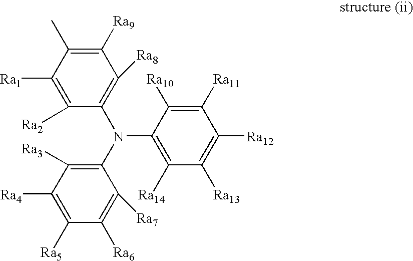
wherein Ra₁-Ra₁₄ are independently selected from the group consisting of a hydrogen atom, a linear alkyl group with up to 10 carbons, a branched alkyl group with up to 10 carbons, and an aromatic group with up to 10 carbons.

Preferably, the polymer is comprised of a polymer selected from the group consisting of the structures (iii) and (iv); 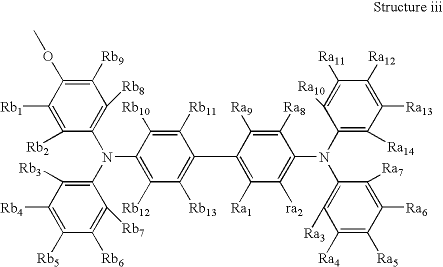
wherein Q represents an alkylene group, with or without a hetero atom, such as oxygen or sulfur, and preferably Q is an alkylene group represented by (CH₂)p, where p is an integer of about 2 to 6; and wherein Rb₁-Rb₁₃ and Ra₁-Ra₁₄ are independently selected from the group consisting of a hydrogen atom, a linear alkyl group with up to 10 carbons, a branched alkyl group with up to 10 carbons, and an aromatic group with up to 10 carbons; and 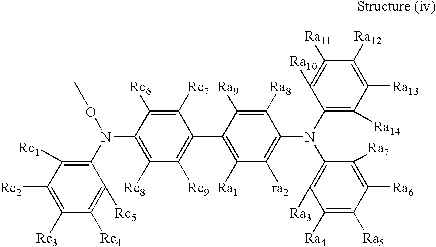
wherein Q represents an alkylene group, with or without a hetero atom, such as oxygen or sulfur, and preferably Q is an alkylene group represented by (CH₂)p, where p is an integer of about 2 to 6; and wherein Rc₁-Rc₉ and Ra₁-Ra₁₄ are independently selected from the group consisting of a hydrogen atom, a linear alkyl group with up to 10 carbons, a branched alkyl group with up to 10 carbons, and an aromatic group with up to 10 carbons.

Particular examples of groups including a phenyl amine moiety as the charge transport component are carbazolylpropyl group; N-(N,N-diphenylamino)-biphenyl-N-phenylamino propyl group; 4-{N-(N,N-diphenylamino)-biphenyl-N-phenylamino}-phenyl propyl group; carbazolylbutyl group; N-(N,N-diphenylamino)-biphenyl-N-phenylamino butyl group; 4-{N-(N,N-diphenylamino)-biphenyl-N-phenylamino}-phenyl butyl group. Such group can be existed in the polymer chain singly or in mixtures of two or more groups.

In a preferred embodiment, a chromophore is comprised of a polymer selected from the group consisting of the structures (v), (vi), (vii), and (viii):
in the formula (v), 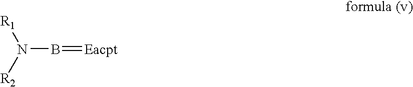
wherein R₁ and R₂ are selected from the group consisting of a linear alkyl group with up to 10 carbons, a branched alkyl group with up to 10 carbons, and an aromatic group with up to 10 carbons; R₁ and R₂ can be either same or different;
wherein B is a group having a bridge of—conjugated bond; and Eacpt is an electron acceptor group.

In the formula (vi), 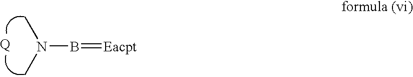
wherein Q represents an alkylene group, with or without a hetero atom; wherein B is a group having a bridge of—conjugated bond; and Eacpt is an electron acceptor group.

In the formula (vii), 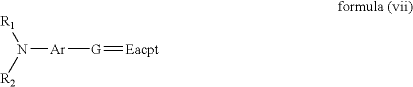
wherein Ar represents an aromatic group, with or without a hetero atom; R₁ and R₂ are selected from the group consisting of a linear alkyl group with up to 10 carbons, a branched alkyl group with up to 10 carbons, and an aromatic group with up to 10 carbons; R₁ and R₂ can be either same or different; G is a group having a bridge of—conjugated bond; and
   Eacpt is an electron acceptor group.

In the formula (viii), 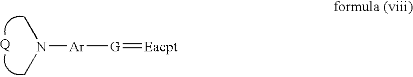
wherein Ar represents an aromatic group, with or without a hetero atom; G is a group having a bridge of—conjugated bond; and Eacpt is an electron acceptor group; Q represents an alkylene group, with or without a hetero atom.

In the above definition, by the term “a bridge of—conjugated bond”, it is meant a molecular fragment that connects two or more chemical groups by—conjugated bond. A—conjugated bond contains covalent bonds between atoms that have bonds and bonds formed between two atoms by overlap of their atomic orbitals (s+p hybrid atomic orbitals for bonds; p atomic orbitals for bonds).

By the term “electron acceptor”, it is meant a group of atoms with a high electron affinity that can be bonded to a—conjugated bridge. Exemplary acceptors, in order of increasing strength, are:
C(O)NR²<C(O)NHR<C(O)NH₂<C(O)OR<C(O)OH<C(O)R<C(O)H<CN<S(O)₂R<NO₂

As typical exemplary electron acceptor groups in the above formulae of (vi), (vii) or (viii), Eacpt is an electron acceptor group and represented by a structure selected from the group consisting of the structures; 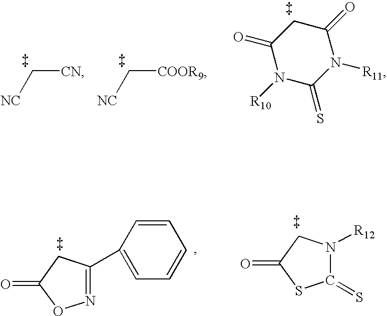
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

Furthermore, as other exemplary electron acceptor groups, functional groups which is described in prior art U.S. Pat. No. 6,267,913 and shown in the following structure figure can be used. The symbol “‡” in a chemical structure herein specifies an atom of attachment to another chemical group and indicates that the structure is missing a hydrogen that would normally be implied by the structure in the absence of the “‡”.

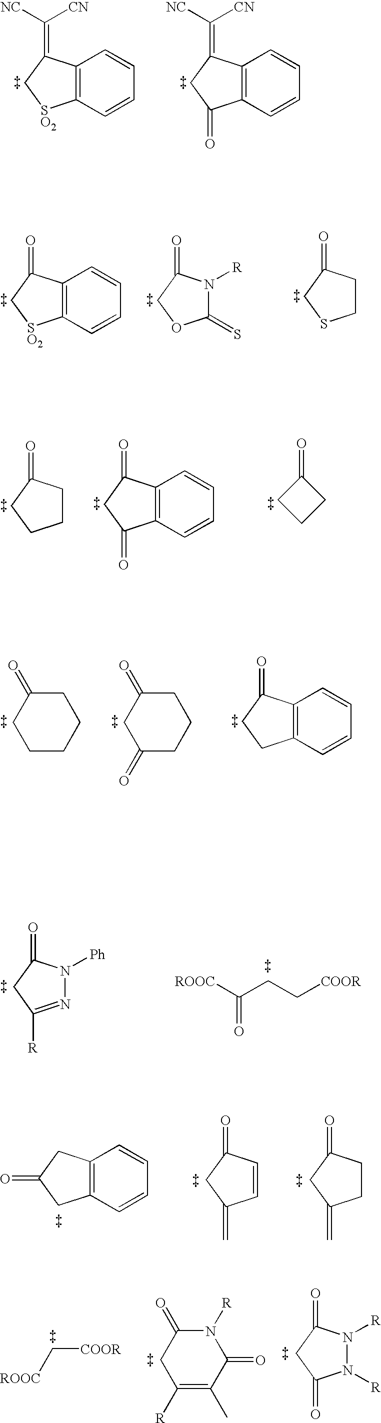

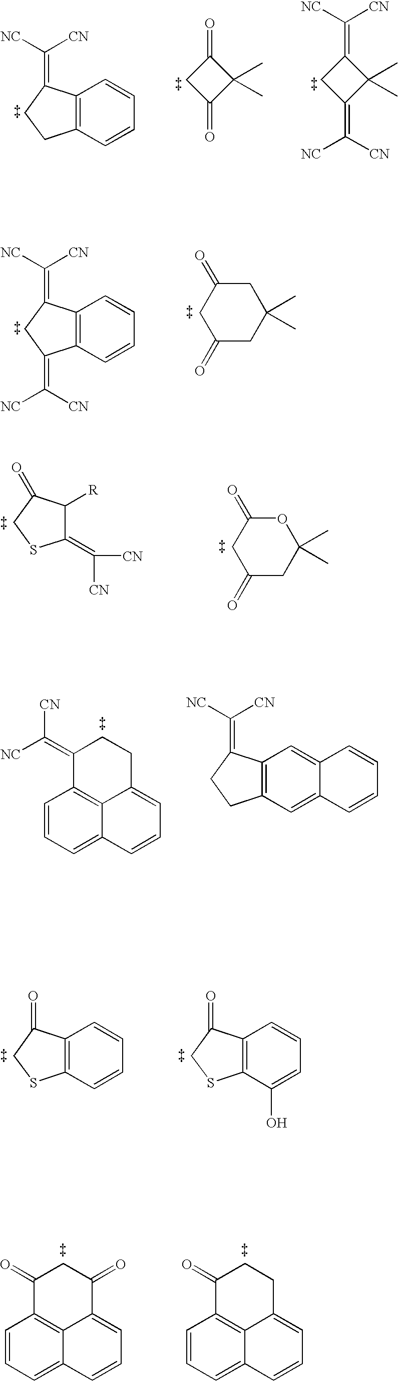

In the above structures, R is selected from the group consisting of a hydrogen atom, a linear alkyl group with up to 10 atoms, a branched alkyl group with up to 10 atoms, and an aromatic group with up to 10 carbons.

Preferably, the chromophore is comprised of a structure represented by the formula (v); 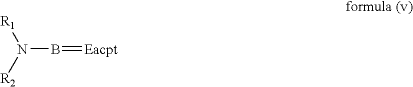
wherein R₁ and R₂ are selected from the group consisting of a linear alkyl group with up to 10 carbons, a branched alkyl group with up to 10 carbons, and an aromatic group with up to 10 carbons; R₁ and R₂ can be either same or different; wherein B is a group selected from the group consisting of the structures (viii), (ix) and (x);
wherein the structures (ix), (x) and (xi) are: 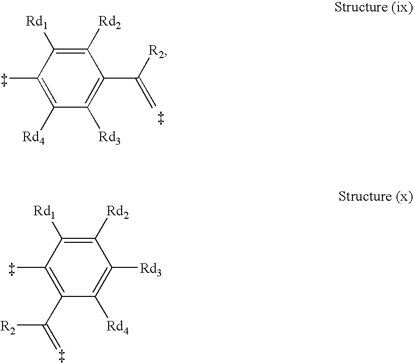
wherein, in both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 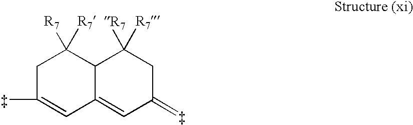
wherein R₇, R₇′, R₇″, and R₇′″ each independently represent a hydrogen or a linear or branched alkyl group with up to 10 carbons; and
wherein Eacpt in the formula (v) is an electron acceptor group and represented by a structure selected from the group consisting of the structures; 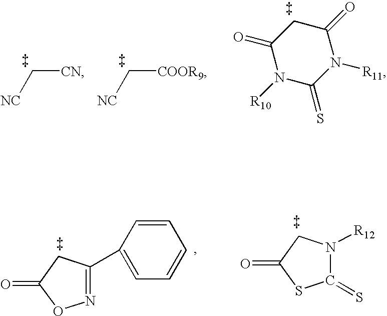
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

Preferably the structure of R₁ and R₂ is selected from the group consisting of methyl, ethyl, propyl, isopropyl, butyl, isobutyl, pentyl, hexyl, and octyl.

Preferably, the chromophore is comprised of a structure represented by the formula (vi); 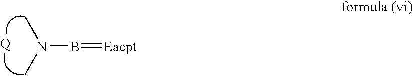
wherein Q represents an alkylene group, with or without a hetero atom; wherein B is a group selected from the group consisting of the above structures (ix), (x) and (xi);
wherein Eacpt in the formula (vi) is an electron acceptor group and represented by a structure selected from the group consisting of the structures which are the same as those shown in the formula (v).

Also, in the above formula (vi), Q represents an alkylene group, with or without a hetero atom.

Preferably the structure of Q is selected from the group consisting of ethylene, propylene, butylene, pentylene, hexylene, and heptylene.

Preferably the structure that provides the non linear optical functionality in the above formulae (v) and (vi) is chosen from the derivatives of the following structures: 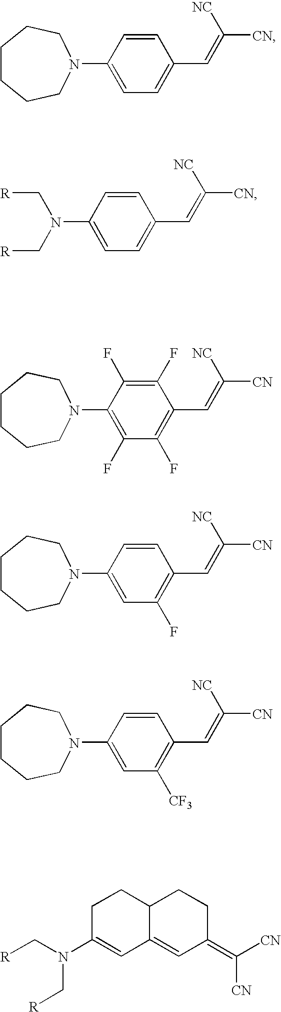
wherein R is a group selected from the group consisting of a hydrogen atom, a linear alkyl group with up to 10 atoms, a branched alkyl group with up to 10 atoms, and an aromatic group with up to 10 carbons.

Preferably, the chromophore is comprised of a structure represented by the formula (vii); 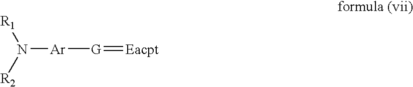
wherein R₁ and R₂ are selected from the group consisting of a linear alkyl group with up to 10 carbons, a branched alkyl group with up to 10 carbons, and an aromatic group with up to 10 carbons; R₁ and R₂ can be either same or different; wherein Z is a group selected from the group consisting of the above structures (ix), (x), and (xi); and
wherein Eacpt in the formula (vii) is an electron acceptor group and represented by a structure selected from the group consisting of the structures which are the same as those shown in the formula (v).

Preferably, the chromophore is comprised of a structure represented by the formula (viii); 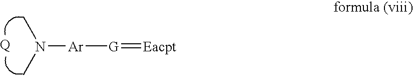
wherein Ar is an aromatic group and selected from phenylene, naphthylene, and thiophenylene; wherein G in the formula (viii) is represented by a structure selected from the group consisting of the structures (xii) and (xiii);
wherein the structures (xii) and (xiii) are: 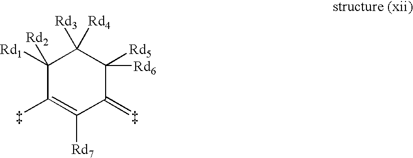
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 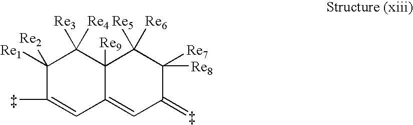
wherein Re₁-Re₉ each independently represent a hydrogen or a linear or branched alkyl group with up to 10 carbons; and
wherein Eacpt is an electron acceptor group and represented by a structure selected from the group consisting of the structures which are the same as those shown in the formula (v).

Preferably the structure of R₁ and R₂ is selected from the group consisting of methyl, ethyl, propyl, isopropyl, butyl, isobutyl, pentyl, hexyl, and octyl.

Also, in the above formula (viii), Q represents an alkylene group, with or without a hetero atom.

Preferably the structure of Q is selected from the group consisting of ethylene, propylene, butylene, pentylene, hexylene, and heptylene.

Most preferably the structure that provides the non linear optical functionality is chosen from the derivatives of the following structures: 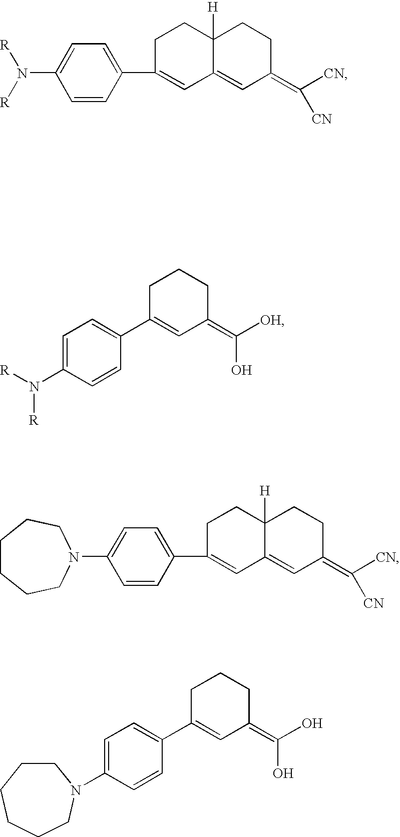
wherein R is a group selected from the group consisting of a hydrogen atom, a linear alkyl group with up to 10 atoms, a branched alkyl group with up to 10 atoms, and an aromatic group with up to 10 carbons.

Furthermore, as other mixable chromophore, a component that possesses non-linear optical properties through the polymer matrix, as is described in U.S. Pat. No. 5,064,264 to IBM, which is incorporated herein by reference, can be used. Suitable materials are known in the art and are well described in the literature, such as in D. S. Chemla & J. Zyss, “Nonlinear Optical Properties of Organic Molecules and Crystals” (Academic Press, 1987). Also, as described in U.S. Pat. No. 6,090,332 to Seth R. Marder et. al., fused ring bridge, ring locked chromophores that form thermally stable photorefractive compositions can be used. For typical, non-limiting examples of chromophore additives, the following chemical structure compounds can be used:

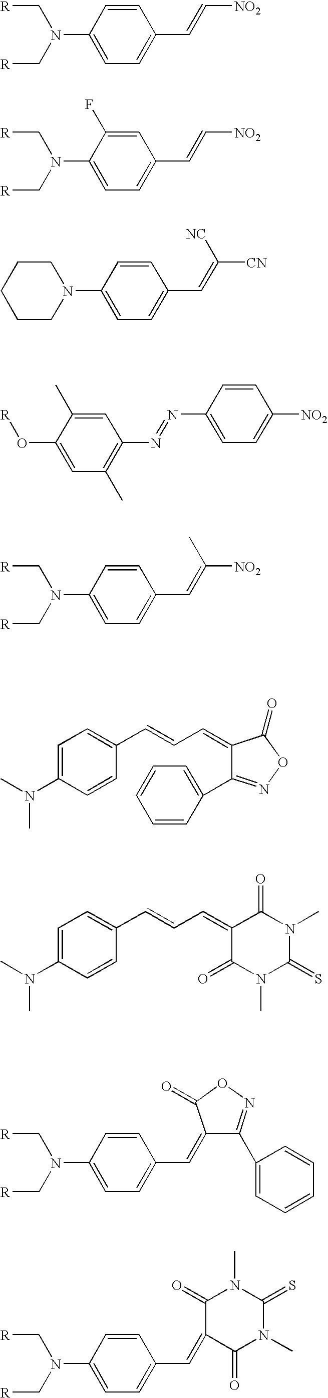

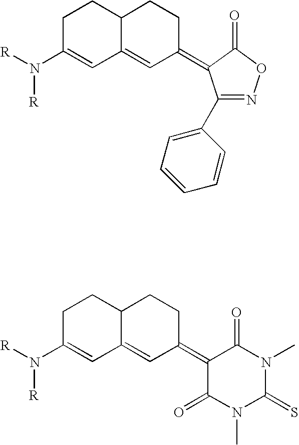

The chosen compound(s) is sometimes mixed in the matrix copolymer in a concentration of about up to 80 wt %, more preferably 40 wt %.

Diverse preparation techniques of polysiloxane based polymers are known in the art. One such conventional technique is ring opeing reaction of corresponding tri- or tetra cyclo-siloxane derivatives in presence of an acid or basic catalyst. In this ring-opening polymerization method, the polymerization catalyst is generally used in an amount of from 0.01 to 5 mol %, preferably from 0.1 to 1 mol %, per mole of the sum of the polymerizable monomers.

Another preparation techniques of polysiloxane based polymers, condensation reaction with pre-synthesized or commercial available poly hydrosilyl type polymer in presence of a rare metal catalyst.

As poly hydrosilyl type polymers, a polymer which is shown in the formula (xiv) can be used.

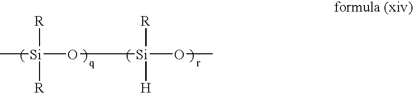

In the formula (xiv), R is selected from the group consisting of a linear alkyl group with up to 10 carbons, a branched alkyl group with up to 10 carbons, and an aromatic group with up to 10 carbons. r and q are independently an integer of 10 to 10,000.

These kinds of poly hydrosilyl type polymers are usually commercially available or synthesized by ring open reaction of the corresponding two monomers, which are shown in the formulae (xv) and (xvi) in presence of an acid or basic catalyst.

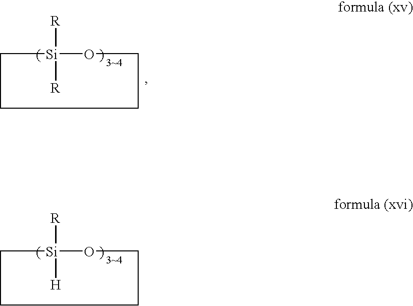

In the formulae (xv) and (xvi), R is selected from the group consisting of a linear alkyl group with up to 10 carbons, a branched alkyl group with up to 10 carbons, and an aromatic group with up to 10 carbons.

In a preferred embodiment, preferably condensation reaction type polymer preparation can be carried out under inactive gas and in the presence of a solvent, such as ethyl acetate, tetrahydrofuran, butyl acetate, toluene or xylene.

In a preferred embodiment, preferably condensation reaction type polymer preparation can be carried out with a rare metal catalyst, such as a compound containing Pd or Pt.

As this condensation reaction, preferably Pt derivative, such as PtCl₆, H₂PtCl₄, Pt (CH═CH₂)Cl₆ can be used.

Usually, the generally used dried gas is, preferably, nitrogen, argon, or helium. Polymerization pressure is from 1 to 50 atom, preferably from 1 to 5 atom.

The solvent is generally used in an amount of from 100 to 1000 wt %, preferably from 100 to 500 wt %, per weight of the sum of the polymerizable monomers.

To initiate the polymerization process, pre-synthesized or commercial available poly hydrosilyl type polymer, the monomer(s) which contain double bond unsaturated bondage, catalyst, and solvent are introduced into the reaction vessel. As the process starts, the catalyst and the monomer(s) which contain double bond unsaturated bondage form a sort of metal complex, which attacks the poly hydrosilyl type polymer and starts the condensation reaction.

The condensation is preferably carried out at a temperature of from about 70° C. to 130° C., and is allowed to continue for about 1 to 100 hours, depending on the desired final molecular weight and polymerization temperature, and taking into account the polymerization rate and deactivation of catalyst.

The inventors have recognized that physical properties of the formed polymer that are of importance are the molecular weight and the glass transition temperature, Tg. Also, it is valuable and desirable, although not essential, that the composition should be capable of being formed into films, coatings and shaped bodies of various kinds by standard polymer processing techniques, such as solvent coating, injection molding and extrusion.

In a preferred embodiment, the polymer generally has a weight average molecular weight, Mw, of from about 3,000 to 500,000, preferably from about 5,000 to 100,000. The term “weight average molecular weight” as used herein means the value determined by the GPC (gel permeation chromatography) method in polystyrene standards, as is well known in the art.

For good photorefractive properties, the photorefractive composition should be substantially amorphous and non-crystalline or non-glassy under the conditions of use. Therefore, it is preferred that the finished photorefractive composition have a relatively low glass transition temperature, Tg, such as below about 50° C., more preferably below about 40° C. Preferred temperature ranges for the Tg are 10-50° C., most preferably 20-40° C. If the pure polymer itself has a glass transition temperature higher than these preferred values, which will generally be the case, components may be added to lower the Tg, as discussed in more detail below.

Nevertheless, it is preferred that the polymer itself has a relatively low glass transition temperature, by which inventors mean a Tg no higher than about 125° C., more preferably no higher than about 120° C., and most preferably no higher than about 110° C. or 100° C.

Particularly, in order to lower glass transition temperature of copolymer itself, the incorporation of plasticizing into the composition can reduce the glass transition temperature more than 50° C. or 20° C., at least 5° C., depending on incorporation ratio.

The copolymer can be mixed with a component that possesses plasticizer properties into the polymer matrix. As preferred plasticizer compounds, any commercial plasticizer compound can be used, such as phthalate derivatives or low molecular weight hole transfer compounds, for example N-alkyl carbazole or triphenylamine derivatives or acetyl carbazole or triphenylamine derivatives.

As detail examples, ethyl catbazole, 4-(N,N-diphenylamino)-phenylpropyl acatate; 4-(N,N-diphenylamino)-phenylmethyloxy acatate; N-(acetoxypropylphenyl)-N,N′,N′-triphenyl-(11,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N, N′-di(4-buthoxyphenyl)-(1,1′-biphenyl)-4,4′-diamine. Such compounds can be used singly or in mixtures of two or more monomers. Also, un-polymerized monomers can be low molecular weight hole transfer compounds, for example 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Preferably, as another type of plasticizer, N-alkyl carbazole or triphenylamine derivatives, which contains electron acceptor group, as depicted in the following structures (xvii), (xviii), or (xix), can be used.

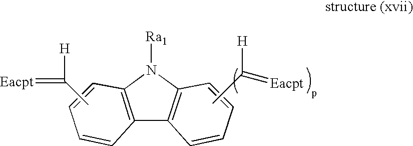

In the structure (xvii), Ra₁is independently selected from the group consisting of a hydrogen atom, a linear alkyl group with up to 10 carbons, a branched alkyl group with up to 10 carbons, and an aromatic group with up to 10 carbons; p is 0 or 1.

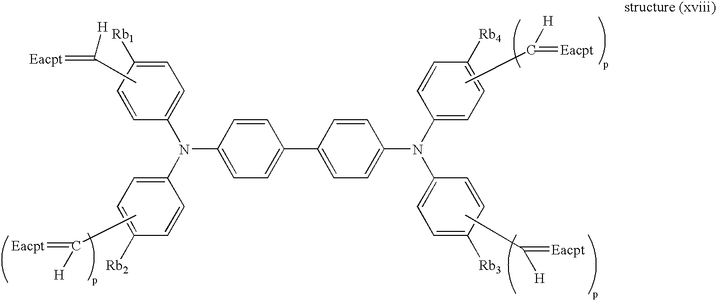

In the structure (xviii), Rb₁-Rb₄ are each independently selected from the group consisting of a hydrogen atom, a linear alkyl group with up to 10 carbons, a branched alkyl group with up to 10 carbons, and an aromatic group with up to 10 carbons; p is 0 or 1.

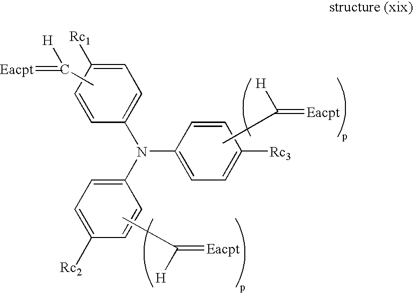

In the structure (xix), Rc₁-Rc₃ are each independently selected from the group consisting of a hydrogen atom, a linear alkyl group with up to 10 carbons, a branched alkyl group with up to 10 carbons, and an aromatic group with up to 10 carbons; p is 0 or 1;
wherein Eacpt is an electron acceptor group and represented by a structure selected from the group consisting of the structures; 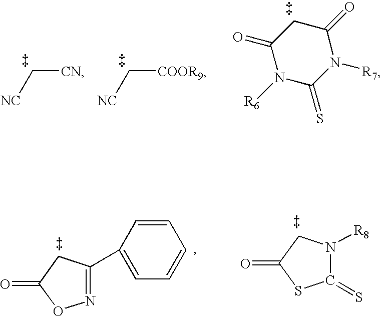
wherein R₅, R₆, R₇ and R₈ are each independently selected from the group consisting of a hydrogen atom, a linear alkyl group with up to 10 atoms, a branched alkyl group with up to 10 atoms, and an aromatic group with up to 10 carbons.

The plascticizer, which is N-alkyl carbazole or triphenylamine derivatives containing electron acceptor group and depicted in the above structures (xvii), (xviii), or (xix), can help the photorefarctive composition more stable, since the plascticizer contains both N-alkyl carbazole or triphenylamine moiety and non-liner optics moiety at same time in one compound.

As detail examples, 2-(4-diphenylamino-benzylidene)-malonitrile, 2-{4-[(4′-diphenylamino-biphenyl-4-yl)-phenyl-amino]-benzylidene}-malonitrile, 2-(4-{[(4′-(phenyl)-p-tolyl-amino)-biphenyl-4-yl]-p-tolyl-amino}-benzylidene)-malonitrile. Such monomers can be used singly or in mixtures of two or more monomers.

In general, the smallest amount of plasticizer required to provide a suitable overall Tg for the composition should be used. Compositions with large amounts of plasticizer tend to have lower stability, as the polymer matrix and the plasticizer may phase separate over time. Also, the photorefractive properties of the material are diminished by dilution of the active components by the plasticizer.

As discussed above, a preferred embodiment provides polymers of comparatively low Tg when compared with similar polymers prepared in accordance with prior art methods. Inventors have recognized that this provides a benefit in terms of lower dependence on plasticizers. By selecting copolymers of intrinsically moderate Tg and by using methods that tend to depress the average Tg, it is possible to limit the amount of plasticizer required for the composition to preferably no more than about 30% or 25%, and more preferably lower, such as no more than about 20%.

Optionally, other components may be added to the polymer matrix to provide or improve the desired physical properties mentioned earlier in this section. Usually, for good photorefractive capability, it is preferred to add a photosensitizer to serve as a charge generator. A wide choice of such photosensitizers is known in the art. Typical, but non-limiting examples of photosensitizers that may be used are 2,4,7-trinitro-9-fluorenone (TNF) and C60. The amount of photosensitizer required is usually less than 3 wt %.

In the art, many of the compositions of the photorefractive polymers showed poor phase stabilities and gave haziness after days. Once the composition films showed the haziness, they don't show good photorefractive properties. This film composition haziness is usually coming from incompatibilities between several photorefractive components. Generally, photorefractive compositions comprise components having charge transport ability and components having non-linear optics ability. The components having charge transport ability are usually hydro-phobic and nonpolar material. On the other hand, components having non-linear optics ability are usually hydrophilic and polar material. Therefore, as a nature of these components, there were tendencies to be phase separated and give hazy compositions.

In the previously described paper (Macromolecules, 2000, 33, 4074), acrylate-based polymers that include carbazole-based side chains and several stilibene-type side chains comprise components having charge transport ability and components having non-linear optics ability. In this paper, it is said these polymers can be expected to have good phase stability, although there is no actual detail data.

However, on the other hand, in a preferred embodiment, the photorefractive polymers composition showed very good phase stabilities and gave no haziness even after several months. They don't change good photorefractive properties, as the composition are very stable and no phase separations are observed. These film composition stabilities are probably due to chromophore structures and/or mixture of different chromophores.

This good phase stabilities of this preferred embodiment last more than a day or a week, or sometimes more than six months. Also, even by heating up the testing samples, which usually enhance phase separation speed, the samples showed very good phase stability for more than a day or a week, or sometimes more than six months. This good phase stability can facilitate the invention copolymer into optical device applications for more commercial products. For acceleration tests, heating test temperature have no restriction, but usually, the temperature is between 40° C. and 120° C., preferably between 60° C. and 80° C.

The photorefractive materials of a preferred embodiment provide combinations of desirable properties not previously available to the art.

A particularly advantageous feature is the fast response time. Response time is the time needed to build up the diffraction grating in the photorefractive material when exposed to a laser writing beam. The response time of a sample of material may be measured by transient four-wave mixing (TFWM) experiments, as detailed in the Examples section below. The data may then be fitted with the following bi-exponential function:
(t)=A sin ²[B(1−a₁e^{t/J1}−a₂e^{t/J2})]
with a₁+a₂=
where (t) is the diffraction efficiency at time t, and A, B, a₁, and a₂ are fitting parameters, J₁ and J₂ are grating build-up times. Between J₁ and J₂, the smaller number is defined as the response time.

Response time is important because a faster response time means faster grating build-up, which enables the photorefractive composition to be used for wider applications, such as real-time hologram applications.

Typical response times for known photorefractive materials range from seconds to sub-seconds. Times longer than 100 ms are common. Faster response times have been reported, see W. F. Moerner, Appl. Phys. Lett., Vol. 73, p. 1490 (1998) but, in order to get these higher speeds, higher field strengths have been required. Such higher field strengths may be difficult in an industrial, rather than a laboratory, environment.

In comparison with typical prior art materials, the photorefractive compositions of a preferred embodiment provide good response times, such as no more than about 50 ms, and preferably faster, such as no more than about 40 ms, no more than about 30 ms, or no more than about 20 ms.

Furthermore, these response times can be achieved without resorting to a very high electric field, expressed as biased voltage. By a very high biased voltage, inventors mean a field in excess of about 100 V/m. In inventors' materials, fast response times can generally be achieved at biased voltages no higher than about 100 V/m, more preferably no higher than about 90 V/m.

And, as discussed with respect to photoconductivity, these good response times can be provided in conjunction with one or more of the other advantageous properties as they are characterized above, such as high photoconductivity, high diffraction efficiency, good processing capabilities, and efficient polymerization techniques.

Yet another advantageous feature is the diffraction efficiency,. Diffraction efficiency is defined as the ratio of the intensity of the diffracted beam to the intensity of the incident probe beam, and is determined by measuring the intensities of the respective beams. Obviously, the closer to 100% is the ratio, the more efficient is the device.

In general, for a given photorefractive composition, a higher diffraction efficiency can be achieved by increasing the applied biased voltage.

In comparison with typical prior art materials, the photorefractive compositions of a preferred embodiment provide good diffraction efficiencies, such as at least about 5%, and preferably higher, such as at least about 10%. And, as discussed with respect to photoconductivity, these good diffraction efficiencies can be provided in conjunction with one or more of the other advantageous properties as they are characterized above, such as high photoconductivity, or fast response time, and in conjunction with good processing capabilities, block copolymer capability, and efficient polymerization techniques.

The invention is now further described by the following examples, which are intended to be illustrative of the invention, but are not intended to limit the scope or underlying principles in any way.

### EXAMPLES

### Production Example 1

(a) Precursors Containing Charge Transport Groups

The following types of charge transport monomers were synthesized as follows.

(i) Tetradiphenyldiamine-type monomer:

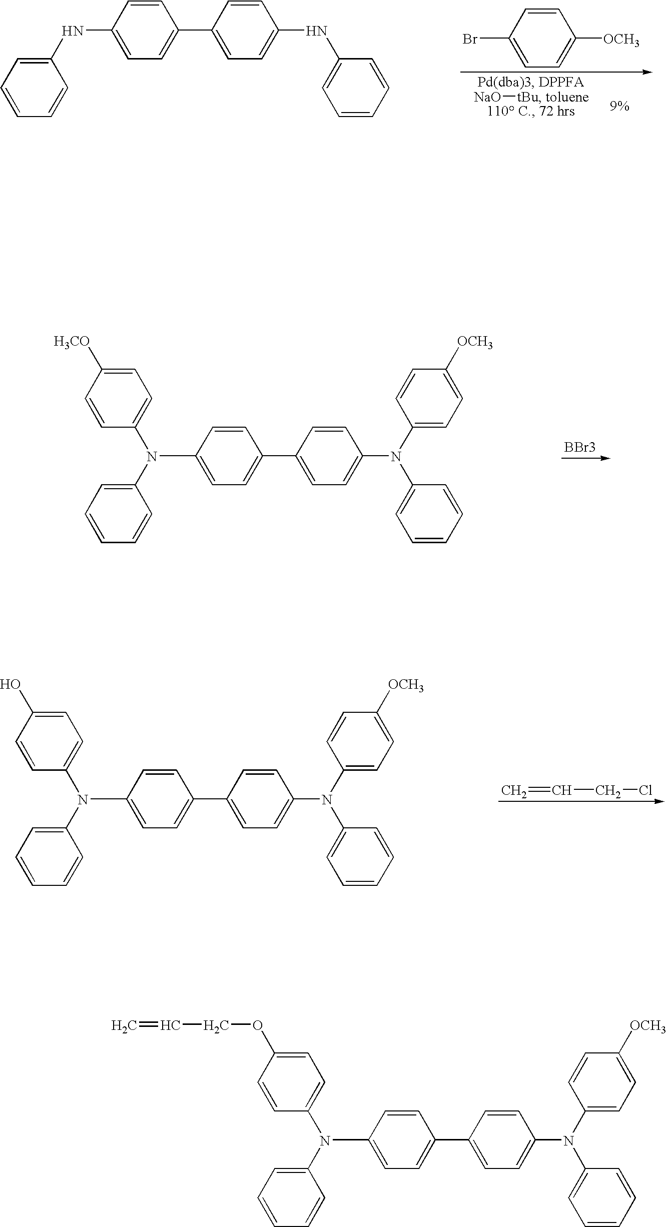

(ii) Tri diphenyldiamine-type monomer:

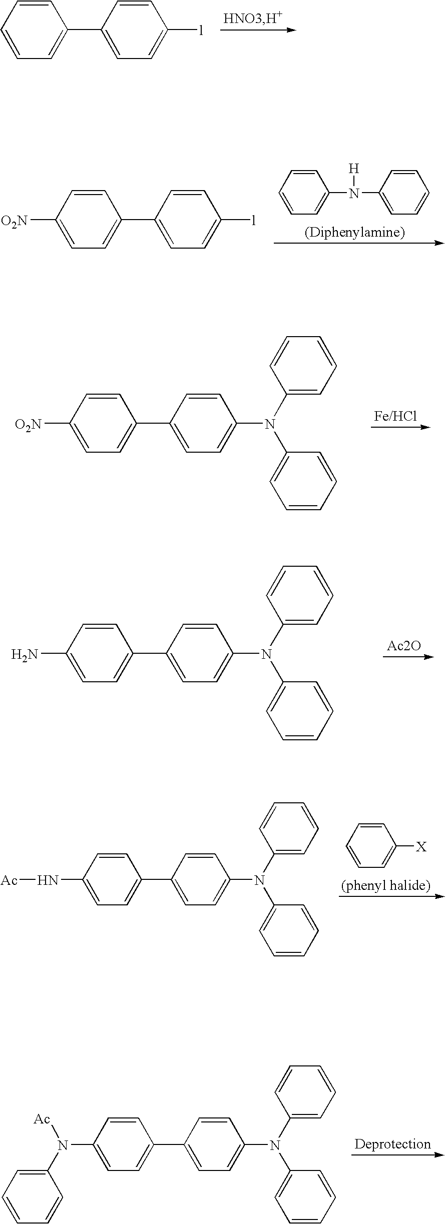

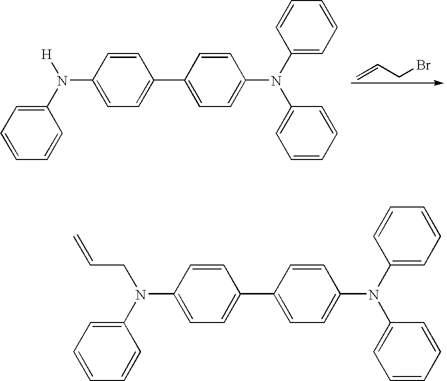

iii) Tri diphenyldiamine-type monomer:

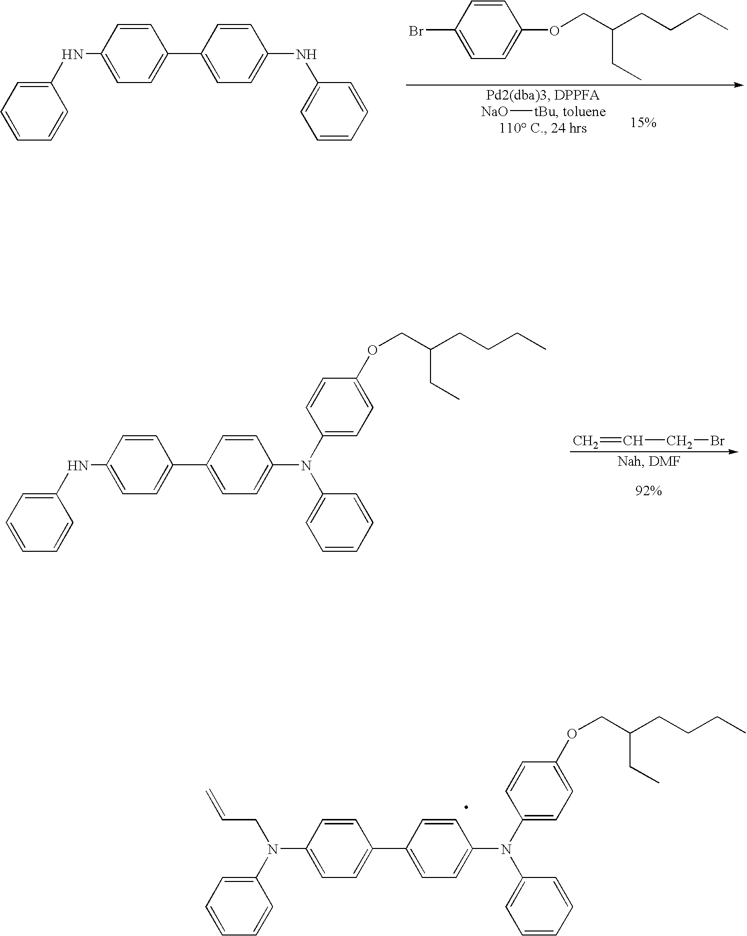

In the above procedure, usage of 3-methyl diphenylamine instead of diphenylamine and 3-methylphenyl halide instead of phenyl halide can result in the formation of N(acroyloxypropylphenyl)-N′-phenyl-N,N′-di(3-methylphenyl)-(1,1′-biphenyl)-4,4′-diamine.

b) Synthesis of Non-Linear-Optical Chromophore 7-DCST

The non-linear-optical precursor 7-DCST (7 member ring dicyanostyrene, 4-homopiperidinobenzylidene malononitrile) was synthesized according to the following two-step synthesis scheme:

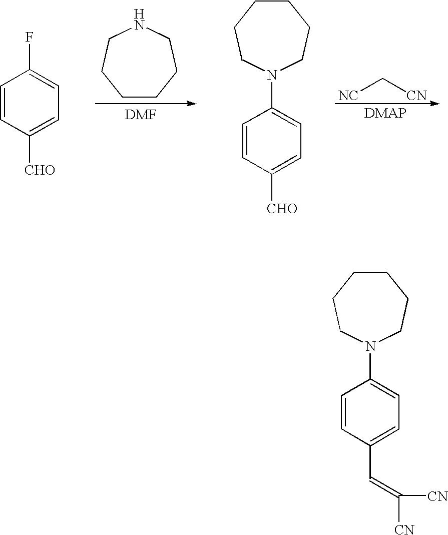

A mixture of 4-fluorobenzaldehyde (17.8 g, 143 mmol), homopiperidine (15.0 g, 151 mmol), lithium carbonate (55 g, 744 mmol), and DMF (100 mL) was stirred at 50° C. for 16 hr. Water (500 mL) was added to the reaction mixture. The products were extracted with ether (1 L). After removal of ether, the crude products were purified by silica gel column chromatography using hexanes-ethyl acetate (9:1) as eluent. 4-(Dimethylamino)pyridine (100 mg, 0.82 mmol) was added to a solution of the 4-homopiperidinobenzaldehyde (18.2 g, 89.5 mmol) and malononitrile (9.1 g, 137.8 mmol) in methanol (60 mL). The reaction mixture was kept at room temperature and the product was collected by filtration and purified by recrystallization from dichloromethane. Yield (17.1 g, 48%)

c) Synthesis of Non-Linear-Optical Chromophore 7-FDCST

The non-linear-optical precursor 7-FDCST (7 member ring dicyanostyrene, 4-homopiperidino-2-fluorobenzylidene malononitrile) was synthesized according to the following two-step synthesis scheme:

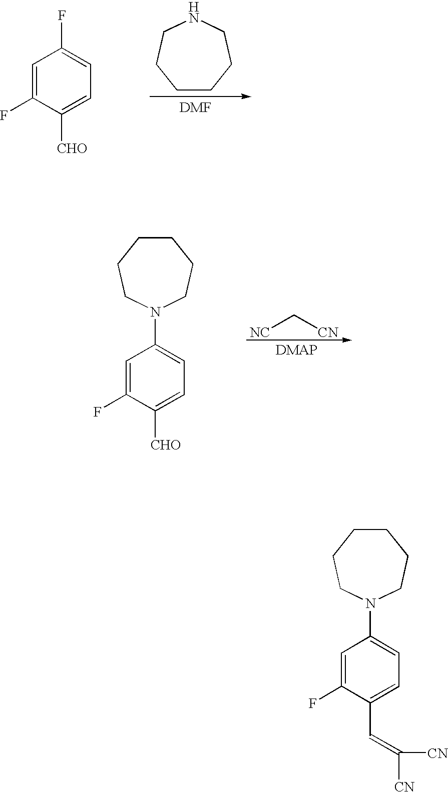

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hr. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol. Yield (18.1 g, 38%)
d) Synthesis of Fused Ring Chromophore RLC (3a) and APDC (3b)

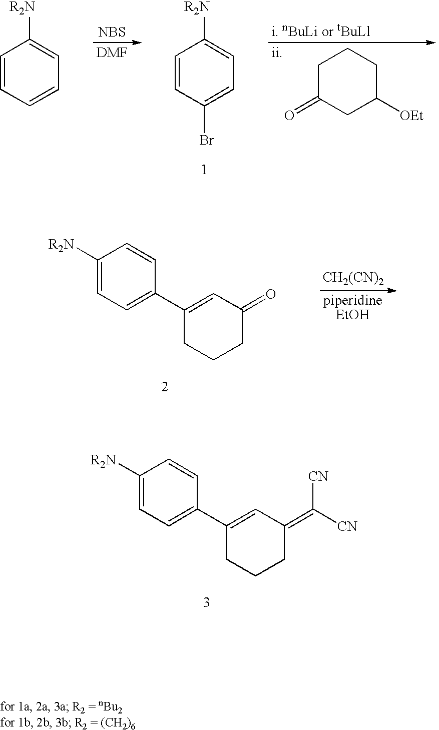

i) RLC (3a)

4-Bromo-N,N-di-n-butylaniline (1a). A solution of N-bromosuccinimide (9.61 g, 0.054 mol) in 25 mL DMF (25 mL) was added to a stirred solution of N,N-di-n-butylaniline (11.0 g, 0.054 mol) in 25 mL N,N-dimethylformamide at 0° C. The resulting green solution was stirred for 12 h at ambient temperature and then poured into 1 L water. The mixture was extracted three times with dichloromethane. The combined organic layers were washed subsequently with water and 200 mL of saturated sodium thiosulfate solution, dried over sodium sulfate, filtered and evaporated to yield 1a as a yellowish oil (14.2 g, 0.050 mol, 93%). ¹H NMR (300 MHz, CDCl₃) 7.23 (d, J=9.1 Hz, 2H, CH); 6.48 (d, J=9.0 Hz, 2H, CH); 3.21 (t, J=8.5 Hz, 4H, CH₂N); 1.52 (q, J=7.6 Hz, 4H, CH₂); 1.34 (q, J=7.3 Hz, 4H, CH₂); 0.93 (t, J=7.3 Hz, 6H, CH₃).

2a. n-Butyllithium (18.9 mL of a 2.5 M solution in hexanes, 0.047 mol) were added to a solution of 1a (12.3 g, 0.043 mol) in dry diethyl ether at −10° C. After stirring for 2 h at −10° C., the reaction mixture was allowed to warm up to 0° C. A solution of 1-ethoxy-2-cyclohexen-3-one (6.02 g, 0.043 mol) in diethyl ether was added. The reaction mixture was warmed to ambient temperature and stirred for 2.5 h. After addition of a saturated aqueous solution of sodium chloride, the organic layer was separated. The aqueous layer was extracted with two portions of diethyl ether. The combined organic layers were dried over sodium sulfate, filtered and evaporated to give a residue, which was purified by column chromatography on silica gel with a mixture of hexanes and ethyl acetate as eluent to give 2a as a yellow solid (10.2, 0.034 mol, 79%). ¹H NMR (300 MHz, CDCl₃) 7.46 (d, J=9.0 Hz, 2H, CH); 6.60 (d, J=8.9 Hz, 2H, CH); 6.38 (s, 1H, CH); 3.29 (t, J=7.6 Hz, 4H, CH₂N); 2.72 (t, J=6.0 Hz, 2H, CH₂); 2.42 (t, J=6.6 Hz, 2H, CH₂); 2.08 (q, J=6.3 Hz, 2H, CH₂); 1.56 (q, J=7.5 Hz, 4H, CH₂); 1.34 (sext, J=7.4 Hz, 4H, CH₂); 0.94 (t, J=7.3 Hz, 6H, CH₃).

3a (RLC). The ketone 2a (2.60 g, 8.7 mmol) was dissolved in the minimum amount of refluxing ethanol and malonodinitrile (3.44 g, 52 mmol) were added, along with a catalytic amount of piperidine. The reaction mixture was stirred at 70° C. for 2 h. The conversion of the starting material was monitored by TLC. The reaction was stopped when a side product was observed. The solvent was evaporated and the dark residue was purified by column chromatography on silica gel with a mixture of hexane and ethyl acetate as eluent, followed by recrystallization from ethanol to yield 3a red needles (1.66 g, 4.8 mmol, 55%) with mp. 101-102° C. ¹H NMR (300 MHz, CDCl₃) 7.56 (d, J=9.1 Hz, 2H, CH): 7.12 (s, 1H, CH); 6.61 (d, J=9.1 Hz, 2H, CH); 3.32 (t, J=7.6 Hz, 4H, NCH₂); 2.75 (t, J=6.4 Hz, 4H, CH₂); 1.95 (quint., J=6.3 Hz, 2H, CH₂); 1.52-1.63 (m, 4H, CH₂); 1.29-1.41 (t d, J_{d}=Jₜ=7.5 Hz, 4H, CH₂); 0.95 (t, J=7.3 Hz, 6H, CH₃).

ii) APDC (3b)

1-Phenyl-azepane was synthesized from the reaction of azepane (also known as hexamethyleneimine and hexahydroazepine), sodium amide, and bromobenzene according to a literature procedure (R. E. Walkup and S. Searles, Tetrahedron, 1985, 41, 101-106). Other starting materials were obtained commercially.

1-(4-Bromophenyl)azepane (1b). A solution of N-bromosuccinimide (1.789 g, 10.1 mmol) in DMF (15 mL) was added dropwise to a solution of 1-phenyl-azepane (1.768 g, 10.1 mmol) in DMF (25 mL) at 0° C. The mixture was allowed to stir and was quenched with 40 mL water after 48 hours. The product was extracted with three 40 mL portions of diethyl ether. The diethyl ether layer was washed with three 40 mL portions of water, then with two 40 mL portions of aqueous 0.01 M sodium thiosulfate, and dried on magnesium sulfate. The diethyl ether was evaporated to afford 1b as a yellowish oil. (1.9721 g, 77.25 mmol, 77% yield). ¹H NMR (CDCl₃, 250 MHz) 7.23 (d, 2H, J=9.2 Hz), 6.53 (d, 2H, J=9.2 Hz), 3.40 (t, 4H, J=5.9 Hz), 1.74 (m, 4H), 1.51 (m, 4H).

2b. 1-(4-Bromophenyl)-azepane (20 g, 78.7 mmol) was dissolved in dry THF (400 mL) under nitrogen gas and cooled to −78° C. tert-Butyl Lithium (92.6 mL of a 1.7 M solution in pentane, 1.45 mol) was added dropwise to the mixture. A solution of 1-ethoxy-2-cyclohexen-3-one (11.45 mL, 78.7 mmol) in dry THF (80 mL) was added dropwise to the mixture. After 36 hours, the reaction was quenched with water (˜250 mL). Reaction was separated with diethyl ether, washed with a saturated sodium chloride solution and dried on magnesium sulfate. The diethyl ether was evaporated and chromatographed on a 8 cm diameter column eluting with 1:1 hexanes/ethyl acetate solution (yellow solid, 16.13 g, 59.8 mmol, 76%). ¹H NMR (CDCl₃, 250 MHz) 7.46 (d, 2H, J=9.0 Hz), 6.66 (d, 2H, J=9.0 Hz), 6.38 (s, 1H, J=2.035 Hz), 3.48 (t, 4H, J=5.88 Hz), 2.72 (t, 2H, J=5.98 Hz), 2.42 (t, 2H, J=6.23 Hz), 2.08 (m, 2H), 1.77 (m, 5H), 1.53 (m, 4H).

3b (APDC). The ketone 2b (7.50 g, 27.8 mmol) and malononitrile (9.5 g, 143.8 mmol) were dissolved in ethanol (300 mL). Pipiridine (˜5 mL) was added to the reaction mixture. Type 4A molecular sieves were added. The reaction mixture turned dark red after a couple of minutes. The reaction was stopped after 4.5 hours. The ethanol was evaporated under reduced pressure. The residue was extracted into ethyl acetate, filtered, and recrystallized to yield a red solid. (7.11 g, 22.4 mol, 80%). ¹H NMR (CDCl₃, 200 MHz) 7.55 (d, 2H, J=8.94 Hz), 7.11 (s, 1H), 6.67 (d, 2H, J=9.1 Hz), 3.51 (t, 4H, J=5.86 Hz), 2.73 (m, 4H), 1.87 (m, 6H), 1.53 (m, 4H).

e) Synthesis of Plasticizer TPD-Ac

The plascticizer TPD-Ac was synthesized from the same intermediate which was used for TPD acrylate synthesis according to the following one-step synthesis scheme:

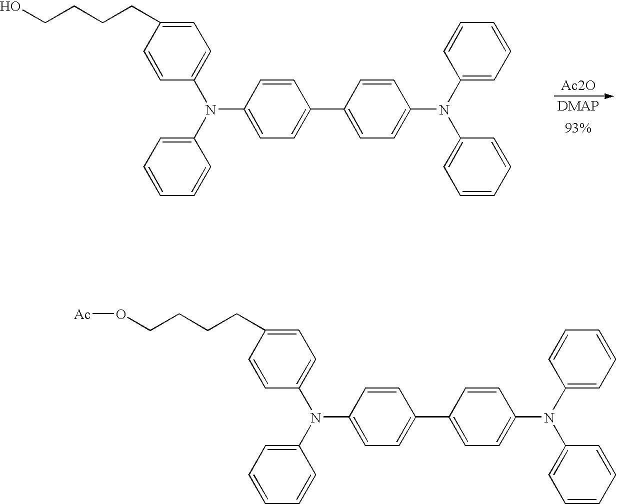

TPD alochol (2.8 g, 5.0 mmol), which was one intermediate for TPD Acrylate monomer, was dissolved with dichloromethane (10 mL). Into this solution, acetic anhydride (0.8 mL, 10.6 mmol) and 4-(Dimethylamino)pyridine (100 mg, 0.82 mmol) were added and stirred at 50° C. for 16 hr. Water (5 mL) was added to the reaction mixture. The products were extracted with dichloromethane (10 mL). After removal of dichloromethane, the crude products were purified by silica gel column chromatography using hexanes-ethyl acetate (1:1) as eluent. The product was collected. Yield (2.97 g, 93%)

f) Synthesis of Plasticizer TPA-Ac

The plascticizer TPA-Ac was synthesized according to the following synthesis scheme: 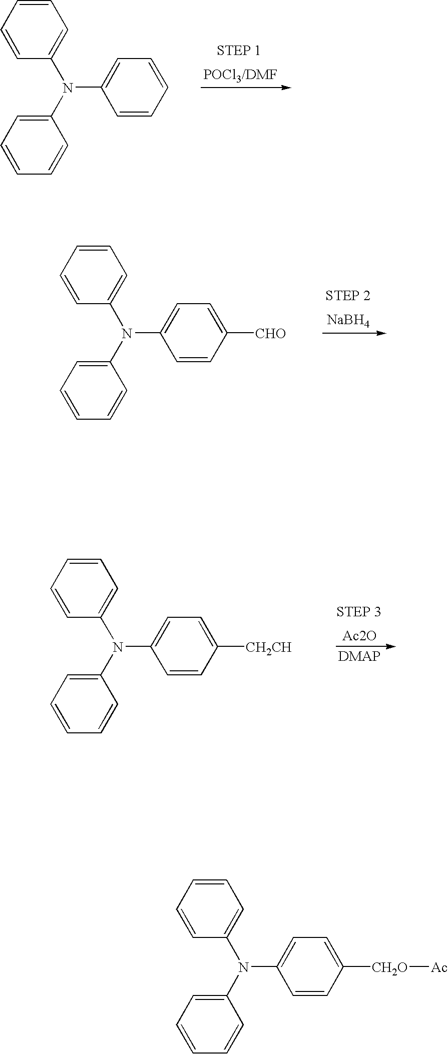
STEP 1:

To a cooled solution of DMF anhydride (17 mL) at 0° C. under Argon atomosphere, phosphorousoxychloride anhydride dropwisely (10 mL, 107.3 mmol) was added. After addition completion combined with triphenylamine (30 g, 122.3 mmol) and DMF anhydride (75 mL). Solution was heated to 80° C. overnight. Extracted the reaction mixture with water (500 mL) and CH₂Cl₂ (500 mL). The CH₂Cl₂ layer was rotary-evaporated and purified by column chromatography (7 CH₂Cl₂:3 hexane). Yield was about 21.9 g (66%).

STEP 2:

A mixture of above aldehyde (11.71 g, 42.8 mmol), 1:1 solution of toluene and ethanol (150 mL), NaBH₄ (2.43 g, 64.2 mmol) was stirred at room temperature under argon atmosphere. After three hours, the filtered solution was rotary-evaporated and extracted with CH₂Cl₂ (400 mL) and water (400 mL). The collected CH₂Cl₂ layer was rotary-evaporated.

Yield was about 12.2 g (quantitively).

STEP 3:

To a stirred solution of alcohol (12.17 g, 44.2 mmol), and pyridine (1.8 mL, 22.2 mmol), and tetrahydrafuran anhydride (100 mL) at 0° C. under argon atmosphere was added dropwisely acetic anhydride (6.2 mL, 65.7 mmol). After 45 min, let warm to ambient temperature. The reaction mixture was extracted with water (500 mL) and CH₂Cl₂ (500 mL). The rotary-evaporated CH₂Cl₂ layer was purified by column chromatography (3 ethyl Acetate: 1 hexanes). Yield was about 10.5 g (75%).

g) Synthesis of Plasticizer TPA-(CN)₂

The plascticizer TPA-Ac was synthesized according to the following synthesis scheme: 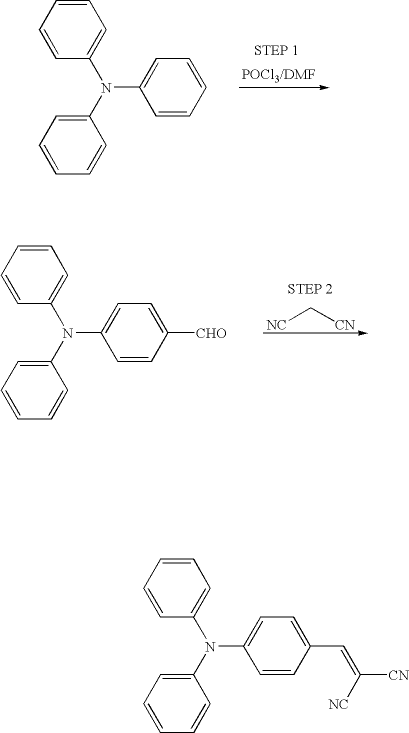
STEP 1:

Same procedure can be taken with the synthetic method for TPA-Ac, described in the above.

STEP 2:

Triphenylamine aldehyde (273 mg, 1.00 mmol) and malonodinitrile (80 mg, 1.2 mmol) were dissolved in dry ethanol (4 mL). The reaction mixture turned dark red after a couple of minutes. The reaction was stopped after 18 hours at 40° C. The mixture was evaporated under reduced pressure and chromatographed on a 60 mL column eluting with 3:2 hexanes/ethyl acetate solution. The product was obtained as red crystals after recrystallization from ethyl acetate. (192 mg, 0.60 mmol, 60% yield).

### Production Example 2

### (Synthesis of tetradiphenyldiamine-type polysiloxane)

Tetradiphenyldiamine-type polysiloxane was prepared by the following procedure

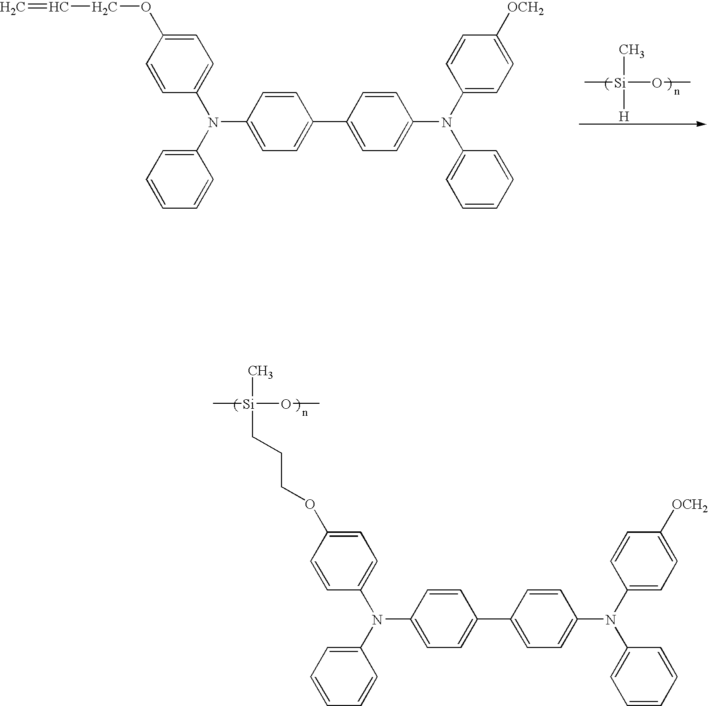

The weight average and number average molecular weights were measured by gel permeation chromatography, using a polystyrene standard. The results were Mn=14,000, Mw=20,000, giving a polydispersity of 1.43. Tg (glass transition temperature) was 85° C.

### Production Example 3

### (Synthesis of tri diphenyldiamine-type polysiloxane)

Tri diphenyldiamine-type polysiloxane was prepared by the following procedure.

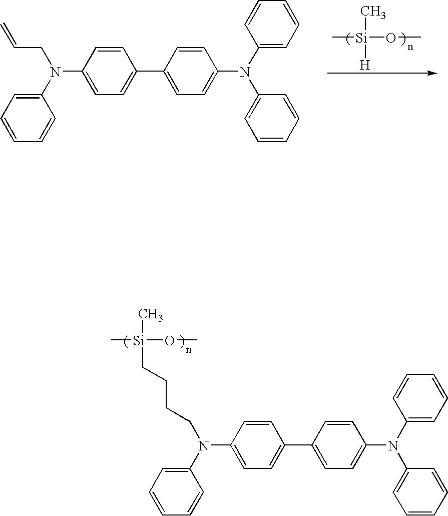

The weight average and number average molecular weights were measured by gel permeation chromatography, using a polystyrene standard. The results were Mn=8,800, Mw=14,600, giving a polydispersity of 1.66. Tg (glass transition temperature) was 72° C.

### Production Example 4

### (Synthesis of iso-octyl tri diphenyldiamine-type polysiloxane)

iso-Octyl tri diphenyldiamine-type polysiloxane was prepared by the following procedure.

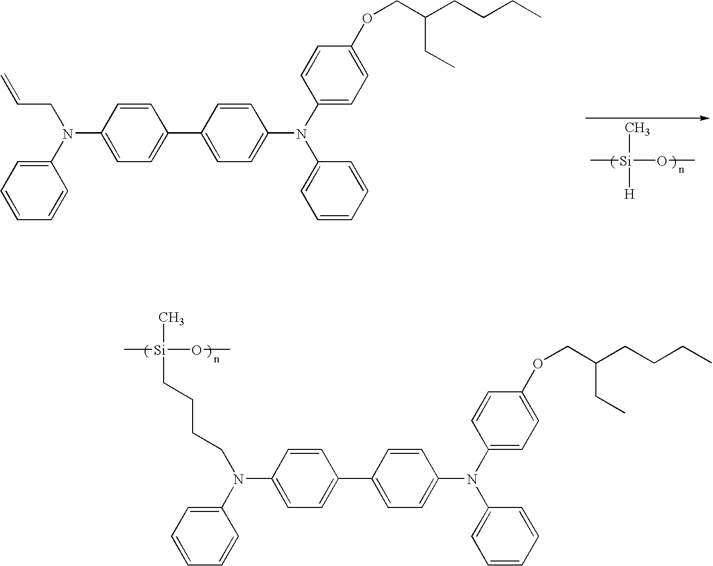

The weight average and number average molecular weights were measured by gel permeation chromatography, using a polystyrene standard. The results were Mn=15,900, Mw=31,100, giving a polydispersity of 1.96. Tg (glass transition temperature) was 48° C.

### Example 1

Preparation of Photorefractive Composition

A photorefractive composition testing sample was prepared. The components of the composition were as follows:

| | |
|---|---|
| (i) tetradiphenyldiamine-type polysiloxane | 69.5 wt % |
| (described in Production Example 2): | |
| (ii) Prepared chromophore powder of 7-DCST | 30 wt % |
| (iii) 2,4,7-trinitro-9-fluorenone-dicyanomalonate (TNFDM) | 0.5 wt % |

To prepare the composition, the components listed above were dissolved with toluene and stirred overnight at room temperature. After removing the solvent by rotary evaporator and vacuum pump, the residue was scratched and collected.

To make testing samples, this powdery residue mixture was put on a slide glass and melted at 125° C. to make a 200-300 m thickness film, or pre-cake. Small portions of this pre-cake were taken off and sandwiched between indium tin oxide (ITO) coated glass plates separated by a 105 m spacer to form the individual samples.

Measurement 1

Diffraction Efficiency

The diffraction efficiency was measured at 633 nm by four-wave mixing experiments. Steady-state and transient four-wave mixing experiments were done using two writing beams making an angle of 20.5 degree in air; with the bisector of the writing beams making an angle of 60 degree relative to the sample normal. The resulting grating period for this geometry was 3.1 m; the grating vector was directed at 60 degree relative to the sample normal.

For the four-wave mixing experiments, two s-polarized writing beams with equal intensity of 0.12 W/cm² in the sample were used; the spot diameter was 600 m. A p-polarized beam of 1.7 mW/cm² counter propagating with respect to the writing beam nearest to the surface normal was used to probe the diffraction gratings; the spot diameter of the probe beam in the sample was 500 m. The diffracted and the transmitted probe beam intensities were monitored to determine the diffraction efficiency. The results are given in Table 1.

Measurement 2

Response Time

The diffraction efficiency was measured as a function of the applied field, using a procedure similar to that described in Measurement 1, by four-wave mixing experiments at 633 nm with s-polarized writing beams and a p-polarized probe beam. The angle between the bisector of the two writing beams and the sample normal was 60 degree and the angle between the writing beams was adjusted to provide a 3.1 m grating spacing in the material (˜20 degree). The writing beams had equal optical powers of 0.45 mW/cm², leading to a total optical power of 0.5 mW on the polymer, after correction for reflection losses. The beams were collimated to a spot size of approximately 500 m. The optical power of the probe was 4 mW. The measurement of the grating buildup time was done as follows: an electric field of 40 V/m was applied to the sample, and the sample was illuminated with one of the two writing beams and the probe beam for 100 ms. Then, the evolution of the diffracted beam was recorded. The response time was estimated as the time required to reach half of steady-state diffraction efficiency.

Measurement 3

Phase Stability

The tested samples were put into an oven at 60° C. At certain intervals, the opaqueness of samples was checked by microscope. If there is no opaqueness and crystal inside the composition, the samples could be said to have good phase stability.

Obtained performance:

| | |
|---|---|
| Diffraction efficiency (%): | 8% at 80 V/m |
| Response time | 23 (ms) at 80 V/m |
| Phase stability (at 60° C.): | good for more than 1 day |

### Example 2

A photorefractive composition was obtained in the same manner as in the Example 1 except components and composition ratio. The components of the composition were as follows:

| | |
|---|---|
| (i) tetradiphenyldiamine-type polysiloxane | 69.5 wt % |
| (described in Production Example 2): | |
| (ii) Prepared chromophore powder of HR-254 | 30 wt % |
| (iii) 2,4,7-trinitro-9-fluorenone-dicyanomalonate | 0.5 wt % |
| (TNFDM) | |
| Obtained performance: | |
| Diffraction efficiency (%): | 10% at 80 V/m |
| Response time | 43 (ms) at 80 V/m |
| Phase stability (at 60° C.): | good for more than 1 |
| | day |

### Example 3

A photorefractive composition was obtained in the same manner as in the Example 1 except components and composition ratio. The components of the composition were as follows:

| | |
|---|---|
| (i) tri diphenyldiamine-type polysiloxane | 49.3 wt % |
| (described in Production Example 3): | |
| (ii) Prepared chromophore powder of RLC | 29.6 wt % |
| (iii) Prepared TPA Acetate plasticizer | 20.6 wt % |
| (iv) C60 | 0.49 wt % |
| Obtained performance: | |
| Diffraction efficiency (%): | 52% at 70 V/m |
| Response time | 8 (ms) at 70 V/m |
| Phase stability (at 60° C.): | good for more than 1 day |

### Example 4

A photorefractive composition was obtained in the same manner as in the Example 1 except components and composition ratio. The components of the composition were as follows:

| | |
|---|---|
| (i) tri diphenyldiamine-type polysiloxane | 49.3 wt % |
| (described in Production Example 3): | |
| (ii) Prepared chromophore powder of APDC | 29.6 wt % |
| (iii) Prepared TPA Acetate plasticizer | 20.6 wt % |
| (iv) C60 | 0.49 wt % |
| Obtained performance: | |
| Diffraction efficiency (%): | 48% at 70 V/m |
| Response time | 11 (ms) at 70 V/m |
| Phase stability (at 60° C.): | good for more than 1 day |

### Example 5

A photorefractive composition was obtained in the same manner as in the Example 1 except components and composition ratio. The components of the composition were as follows:

| | |
|---|---|
| (i) iso-octyl tri diphenyldiamine-type polysiloxane | 69.5 wt % |
| (described in Production Example | |
| (ii) Prepared chromophore powder of 7-DCST | 30 wt % |
| (iii) 2,4,7-trinitro-9-fluorenone-dicyanomalonate | 0.5 wt % |
| (TNFDM) | |
| Obtained performance: | |
| Diffraction efficiency (%): | 20% at 60 V/m |
| Response time | 56 (ms) at 60 V/m |
| Phase stability (at 60° C.): | good for more than 1 |
| | day |

### Comparative Example

A poly(n-vinylcarbazole) (Aldrich Chemicals, Milwaukee, Wis.) was purchased. A photorefractive composition was obtained in the same manner as in the Example 1 except that poly(n-vinylcarbazole) was used, ethyl carbazole was used instead of TPD acetate plasticizer and composition ratio was changed as follows:

| | |
|---|---|
| (i) poly(n-vinylcarbazole | 49.5 wt % |
| (ii) Prepared chromophore powder of 7-DCST | 35 wt % |
| (iii) Ethyl carbazole | 15 wt % |
| (iii) C60 | 0.5 wt % |
| Obtained performance: | |
| Diffraction efficiency (%): | 30% at 60 V/m |
| Response time | 48 (ms) at 60 V/m |
| Phase stability (at 60° C.): | Phase separation within |
| | 1 days |

With compared to the Comparative Example, the composition of a preferred embodiment showed faster response time and better diffraction efficiency, along with good phase stabilities.

1. A composition comprising a polymer represented by the following formula (i), wherein the composition exhibits photorefractive ability: 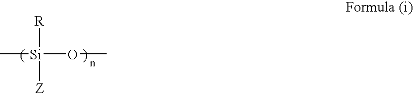
wherein R is selected from the group consisting of a linear alkyl group with up to 10 carbons, a branched alkyl group with up to 10 carbons, and an aromatic group with up to 10 carbons; n is an integer of 10 to 10,000; Z is a group which contains at least a tri-aromatic amine moiety shown in the structure (ii): 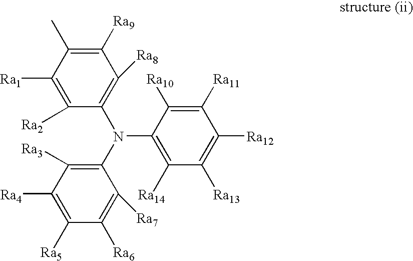
wherein Ra₁-Ra₁₄ are independently selected from the group consisting of a hydrogen atom, a linear alkyl group with up to 10 carbons, a branched alkyl group with up to 10 carbons, and an aromatic group with up to 10 carbons.

2. The composition of claim 1,
wherein said Z in said formula (i) is represented by a structure selected from the group consisting of the structures (iii) and (iv): 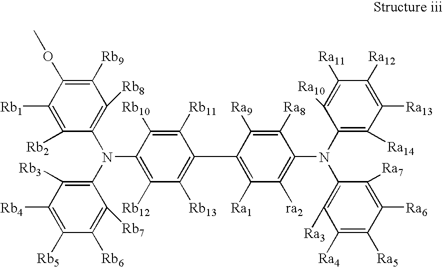
wherein Q represents an alkylene group, with or without a hetero atom; and Rb₁-Rb₁₃ and Ra₁-Ra₁₄ are independently selected from the group consisting of a hydrogen atom, a linear alkyl group with up to 10 carbons, a branched alkyl group with up to 10 carbons, and an aromatic group with up to 10 carbons; and 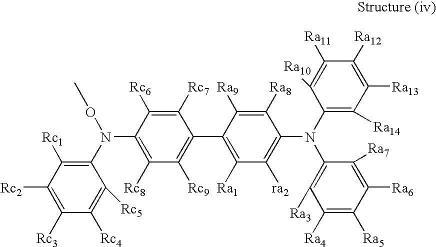
wherein Q represents an alkylene group, with or without a hetero atom; and Rc₁-Rc₉ and Ra₁-Ra₁₄ are independently selected from the group consisting of a hydrogen atom, a linear alkyl group with up to 10 carbons, a branched alkyl group with up to 10 carbons, and an aromatic group with up to 10 carbons.

3. The composition of claim 1, further comprising at least one chromophore selected from the group consisting of the following formulae (v), (vi), (vii), and (viii): 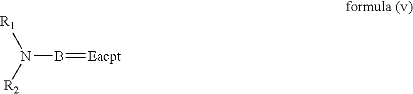
wherein R₁ and R₂ are selected from the group consisting of a linear alkyl group with up to 10 carbons, a branched alkyl group with up to 10 carbons, and an aromatic group with up to 10 carbons; R₁ and R₂ can be either same or different; B is a group having a bridge of—conjugated bond; and Eacpt is an electron acceptor group; 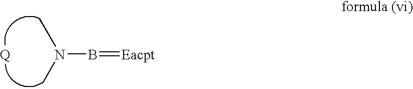
wherein Q represents an alkylene group, with or without a hetero atom; B is a group having a bridge of—conjugated bond; and Eacpt is an electron acceptor group; 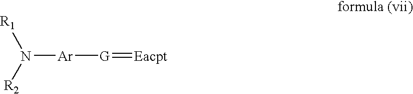
wherein Ar represents an aromatic group, with or without a hetero atom; R₁ and R₂ are selected from the group consisting of a linear alkyl group with up to 10 carbons, a branched alkyl group with up to 10 carbons, and an aromatic group with up to 10 carbons; R₁ and R₂ can be either same or different; G is a group having a bridge of—conjugated bond; and Eacpt is an electron acceptor group; 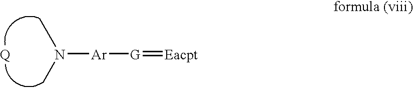
wherein Ar represents an aromatic group, with or without a hetero atom; G is a group having a bridge of—conjugated bond; Eacpt is an electron acceptor group; and Q represents an alkylene group, with or without a hetero atom.

4. The composition of claim 2, further comprising at least one chromophore selected from the group consisting of the following formulae (v), (vi), (vii), and (viii): 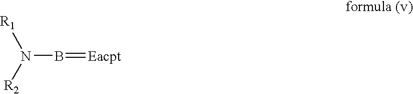
wherein R₁ and R₂ are selected from the group consisting of a linear alkyl group with up to 10 carbons, a branched alkyl group with up to 10 carbons, and an aromatic group with up to 10 carbons; R₁ and R₂ can be either same or different; B is a group having a bridge of—conjugated bond; and Eacpt is an electron acceptor group; 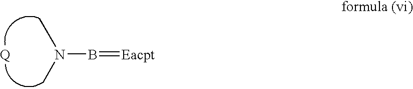
wherein Q represents an alkylene group, with or without a hetero atom; B is a group having a bridge of—conjugated bond; and Eacpt is an electron acceptor group; 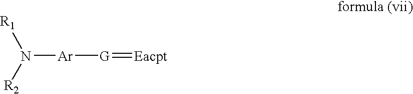
wherein Ar represents an aromatic group, with or without a hetero atom; R₁ and R₂ are selected from the group consisting of a linear alkyl group with up to 10 carbons, a branched alkyl group with up to 10 carbons, and an aromatic group with up to 10 carbons; R₁ and R₂ can be either same or different; G is a group having a bridge of—conjugated bond; and Eacpt is an electron acceptor group; 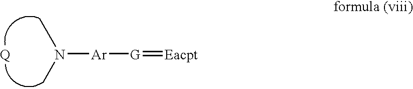
wherein Ar represents an aromatic group, with or without a hetero atom; G is a group having a bridge of—conjugated bond; Eacpt is an electron acceptor group; and Q represents an alkylene group, with or without a hetero atom.

5. The composition of claim 3, wherein said B in said formula (v) is a group selected from the group consisting of the structures (ix), (x) and (xi);
wherein the structures (ix), (x) and (xi) are: 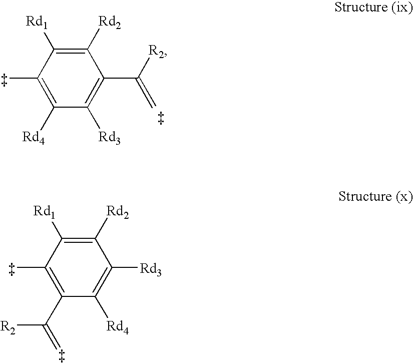
wherein, in the both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 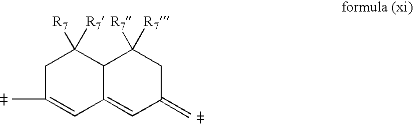
wherein R₇, R₇′, R₇″, and R₇′″ represent each independently a hydrogen or a linear or branched alkyl group with up to 10 carbons; and
wherein said Eacpt in said formula (v) is an electron acceptor group represented by a structure selected from the group consisting of the following structures; 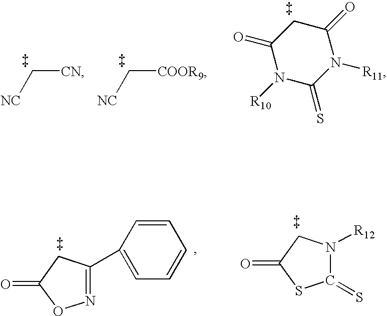
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

6. The composition of claim 4, wherein said B in said formula (v) is a group selected from the group consisting of the structures (ix), (x) and (xi);
wherein the structures (ix), (x) and (xi) are: 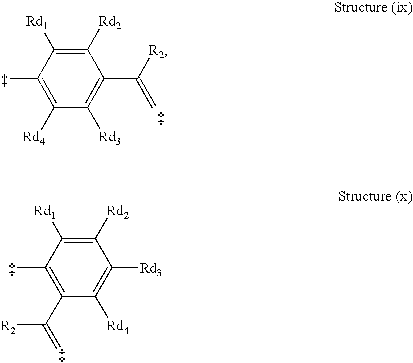
wherein, in the both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 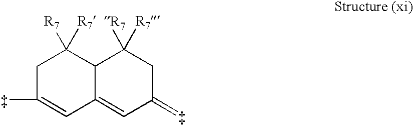
wherein R₇, R₇′, R₇″, and R₇′″ represent each independently a hydrogen or a linear or branched alkyl group with up to 10 carbons; and
wherein said Eacpt in said formula (v) is an electron acceptor group represented by a structure selected from the group consisting of the following structures; 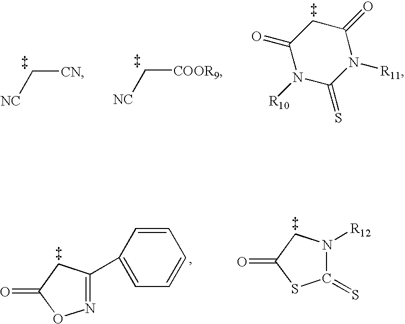
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

7. The composition of claim 3,
wherein said B in said formula (vi) is a group selected from the group consisting of the structures (ix), (x) and (xi);
wherein the structures (ix), (x) and (xi) are: 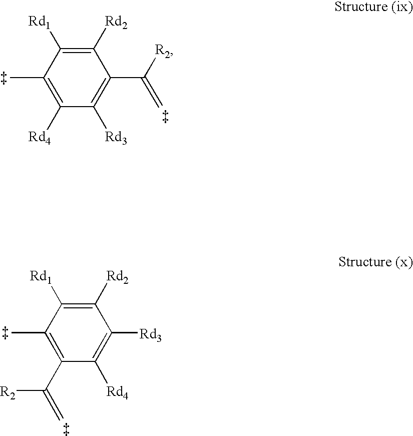
wherein, in the both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 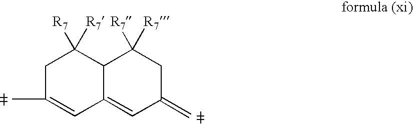
wherein R₇, R₇′, R₇″, and R₇′″ represent each independently a hydrogen or a linear or branched alkyl group with up to 10 carbons; and
wherein said Eacpt in said formula (vi) is an electron acceptor group represented by a structure selected from the group consisting of the structures; 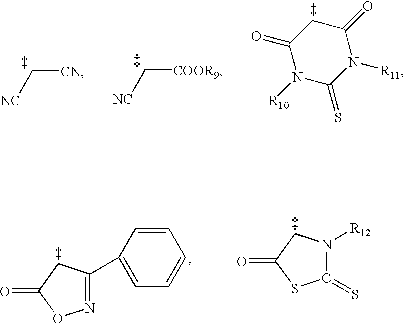
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

8. The composition of claim 4,
wherein said B in said formula (vi) is a group selected from the group consisting of the structures (ix), (x) and (xi);
wherein the structures (ix), (x) and (xi) are: 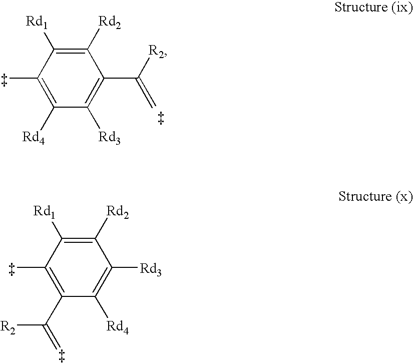
wherein, in the both structures (ix) and (x), Rd₁-Rd₄ are each independently selected from the group consisting of a hydrogen atom, a linear alkyl group with up to 10 atoms, a branched alkyl group with up to 10 atoms, and an aromatic group with up to 10 carbons; R₂ is selected from the group consisting of a hydrogen atom, a linear alkyl group with up to 10 atoms, a branched alkyl group with up to 10 atoms, and an aromatic group with up to 10 carbons; 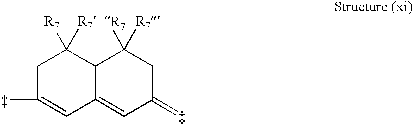
wherein R₇, R₇′, R₇″, and R₇′″ represent each independently a hydrogen or a linear or branched alkyl group with up to 10 carbons; and
wherein said Eacpt in said formula (vi) is an electron acceptor group represented by a structure selected from the group consisting of the structures; 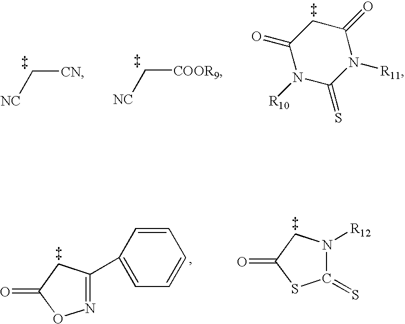
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

9. The composition of claim 3,
wherein said Ar in said formula (vii) is an aromatic group selected from phenylene, naphthylene, or thiophenylene;
wherein said G in said formula (vii) is represented by a structure selected from the group consisting of the structures (xii) and (xiii);
wherein the structures (xii) and (xiii) are:
Structure (xii) 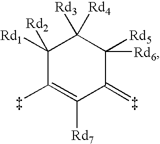
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 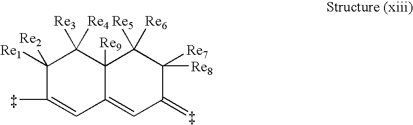
wherein Re₁-Re₉ each independently represent a hydrogen or a linear or branched alkyl group with up to 10 carbons; and
wherein said Eacpt in said formula (vii) is an electron acceptor group represented by a structure selected from the group consisting of the following structures; 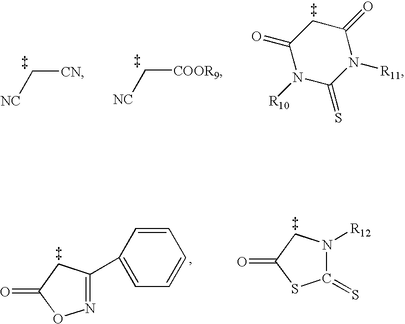
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

10. The composition of claim 4,
wherein said Ar in said formula (vii) is an aromatic group selected from phenylene, naphthylene, or thiophenylene;
wherein said G in said formula (vii) is represented by a structure selected from the group consisting of the structures (xii) and (xiii);
wherein the structures (xii) and (xiii) are:
Structure (xii) 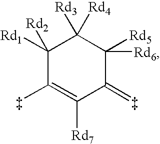
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 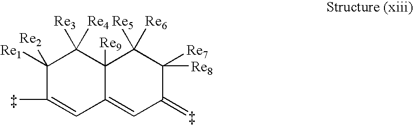
wherein Re₁-Re₉ each independently represent a hydrogen or a linear or branched alkyl group with up to 10 carbons; and
wherein said Eacpt in said formula (vii) is an electron acceptor group represented by a structure selected from the group consisting of the following structures; 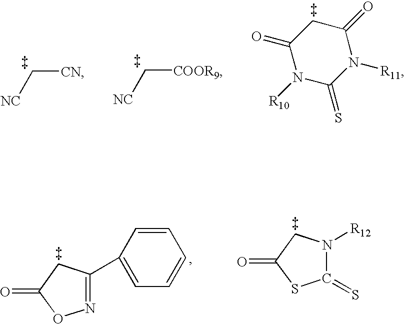
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

11. The composition of claim 3,
wherein said Ar in said formula (viii) is an aromatic group selected from phenylene, naphthylene, and thiophenylene;
wherein said G in said formula (viii) is represented by a structure selected from the group consisting of the structures (xii) and (xiii);
wherein the structures (xii) and (xiii) are:
Structure (xii) 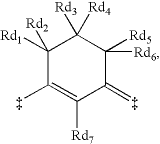
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 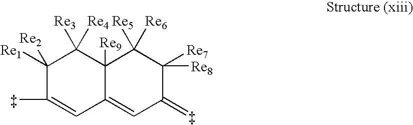
wherein Re₁-Re₉ each independently represent a hydrogen or a linear or branched alkyl group with up to 10 carbons; and
wherein said Eacpt in said formula (viii) is an electron acceptor group represented by a structure selected from the group consisting of the following structures; 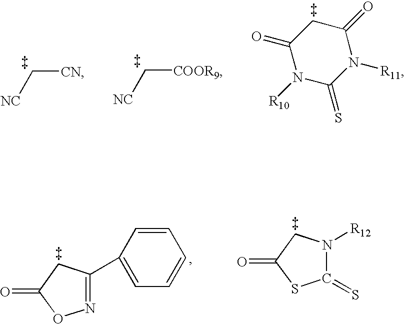
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

12. The composition of claim 4,
wherein said Ar in said formula (viii) is an aromatic group selected from phenylene, naphthylene, and thiophenylene;
wherein said G in said formula (viii) is represented by a structure selected from the group consisting of the structures (xii) and (xiii);
wherein the structures (xii) and (xiii) are:
Structure (xii) 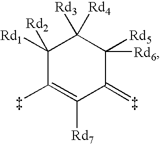
wherein, Rd₁-Rd₇ are each independently selected from the group consisting of a hydrogen atom, a linear alkyl group with up to 10 atoms, a branched alkyl group with up to 10 atoms, and an aromatic group with up to 10 carbons; 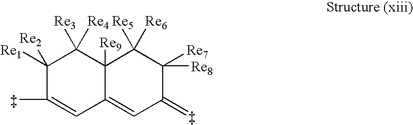
wherein Re₁-Re₉ each independently represent a hydrogen or a linear or branched alkyl group with up to 10 carbons; and
wherein said Eacpt in said formula (viii) is an electron acceptor group represented by a structure selected from the group consisting of the following structures; 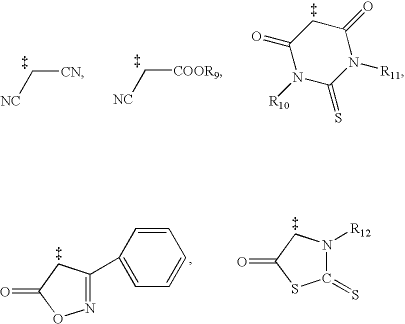
wherein R₉, R₁₀, R₁₁ and R₁₂ are each independently selected from the group consisting of a hydrogen atom, a linear alkyl group with up to 10 atoms, a branched alkyl group with up to 10 atoms, and an aromatic group with up to 10 carbons.

13. The composition of claim 1, further comprising a plasticizer and a sensitizer.

14. The composition of claim 2, further comprising a plasticizer and a sensitizer.

15. The composition of claim 3, further comprising a plasticizer and a sensitizer.

16. The composition of claim 4, further comprising a plasticizer and a sensitizer.

17. The composition of claim 5, further comprising a plasticizer and a sensitizer.

18. The composition of claim 6, further comprising a plasticizer and a sensitizer.

19. The composition of claim 7, further comprising a plasticizer and a sensitizer.

20. The composition of claim 8, further comprising a plasticizer and a sensitizer.

21. The composition of claim 9, further comprising a plasticizer and a sensitizer.

22. The composition of claim 10, further comprising a plasticizer and a sensitizer.

23. The composition of claim 11, further comprising a plasticizer and a sensitizer.

24. The composition of claim 12, further comprising a plasticizer and a sensitizer.
